(19) United States
(12) Patent Application Publication
(10) Pub. No.: US 2019/0139277 A1
(43) Pub. Date: May 9, 2019

(54) EFFICIENTLY MODELING BRISTLE DEFORMATION TO GENERATE REALISTIC DIGITAL PAINT STROKES

(71) Applicant: Adobe Inc., San Jose, CA (US)

(72) Inventors: Zhili Chen, San Jose, CA (US); Byungmoon Kim, Sunnyvale, CA (US)

(21) Appl. No.: 15/803,084

(22) Filed: Nov. 3, 2017

(51) Int. Cl. G06T 11/20; G06T 1/20; G06T 11/40; G06T 19/20

(52) U.S. Cl. CPC G06T 11/203; G06T 1/20; G06T 2200/24; G06T 19/20; G06T 11/40

(57) ABSTRACT

The present disclosure relates to a brush deformation system that efficiently models bristles of a digital brush to generate realistic digital paintings. In particular, the brush deformation system can intuitively and realistically model bristle deformation and splitting in response to user drawing input. For example, in various embodiments, the brush deformation system utilizes a digital cage and corresponding deformation weights to collectively model a plurality of bristles in a digital brush. In addition, the brush deformation system can model brush tip splitting using a bristle spreading modifier that accurately models splitting effects that result from pressure being applied to the digital brush. Further, the brush deformation system can leverage GPU architecture to efficiently render digital strokes.

### BACKGROUND

In recent years, developers have generated a variety of hardware and software platforms for creating digital drawings. Indeed, utilizing these platforms, computing devices now enable many artists to create, edit, save, and share digital creative works. For example, the development of digital painting systems has enabled individuals and businesses to generate digital paintings without the necessity of purchasing, accessing, or utilizing traditional painting tools and supplies.

Although conventional digital painting systems allow users to generate digital paintings, such systems still suffer from a number of disadvantages. For example, conventional digital painting systems fail to accurately recreate the appearance, strokes, and effects of physical paintbrushes on a tangible canvas. Indeed, conventional digital painting systems generally fail to accurately model the interplay between paint, brushes, bristles, and canvas that give tangible painting such a rich texture, appearance, and impact.

To illustrate, some conventional digital painting systems utilize digital paintbrushes in the form of a two-dimensional circle, rectangle, or another pre-defined stamp pattern to generate digital strokes (e.g., by stamping the two-dimensional patterns along a path). These conventional digital painting systems allow users to generate digital paintings, but the resulting digital paintings are poor analogs to paintings resulting from real paintbrushes. Indeed, a real paintbrush deforms when it contacts a canvas such that the bristles on the paintbrush create interesting, aesthetically pleasing stroke patterns. Further, real paintings reflect force, angle, and movement applied to a paintbrush. Conventional digital painting systems fail to model the physical properties of real paintbrushes and, thus, fail to recreate realistic stroke patterns in digital paintings.

Some modern digital painting systems have begun to provide more realistic digital paintings that mimic tangible paintings created with a real paintbrush. However, these modern systems require significant computer memory and computational resources. For instance, some modern digital painting systems individually model the physical movement of each bristle in a brush, thus producing more realistic digital strokes. However, such modern digital painting systems require significant computational cost to model each individual bristle, a cost that increases with the number of bristles included in a digital paintbrush. Thus, modern digital painting systems can exhaust the computational power available from most computing systems (e.g., laptops, tablets, and/or smartphones) with only a limited number of bristles (e.g., ten bristles in a brush). Accordingly, modern digital painting systems are still incapable of quickly approximating the rich texture and effect of a tangible painting medium on computing devices accessible to most individuals and businesses.

These along with additional problems and issues exist with regard to conventional and modern digital painting systems and methods.

### SUMMARY

One or more embodiments of the present disclosure provide benefits and/or solve one or more of the preceding (or other problems) in the art, with systems, computer-readable media, and methods that efficiently model bristles of a digital brush to generate realistic digital paintings. For example, in one or more embodiments, the disclosed systems utilize a digital cage and corresponding deformation weights to collectively model a plurality of bristles in a digital brush. In particular, in response to drawing input, the disclosed systems can model deformation of the digital cage resulting from the drawing input and then determine spatial locations of individual bristles by applying deformation weights to the deformed digital cage.

Furthermore, the disclosed systems can utilize a bristle spreading modifier to efficiently model splitting effects that result from pressure being applied to the digital brush. In particular, the disclosed systems can determine a bristle spreading modifier that varies based on vertical location along the digital brush and/or the amount of pressure applied to the digital brush. Moreover, the disclosed systems can apply the bristle spreading modifier to accurately and efficiently model bristle splitting effects.

Moreover, the disclosed systems can utilize an efficient single-call stroke rendering technique that efficiently leverages the GPU architecture of an implementing computing device. In particular, the disclosed systems can utilize a single GPU draw call to render each pixel in a digital stroke in a single pass. Utilizing one or more of the foregoing approaches, the disclosed systems can determine individual bristle locations in relation to a digital canvas to generate realistic digital strokes while significantly reducing computational cost.

The following description sets forth additional features and advantages of one or more embodiments of the disclosed systems and methods. In some cases, such features and advantages will be obvious to a skilled artisan from the description or can be learned by the practice of the disclosed embodiments.

### BRIEF DESCRIPTION OF THE DRAWINGS

The detailed description describes one or more embodiments with additional specificity and detail through the use of the accompanying drawings, as briefly described below.

FIGS. 1A and 1B illustrate generating digital strokes in accordance with one or more embodiments.

FIGS. 2A-2D illustrate a two-dimensional representation of deforming bristles in a digital brush using a digital cage and a deformation weight in accordance with one or more embodiments.

FIGS. 3A and 3B illustrate a three-dimensional representation of deforming bristles in a digital brush using a digital cage and a deformation weight in accordance with one or more embodiments.

FIGS. 4A-4C illustrate a representation of spreading bristles in a digital brush using a bristle spreading modifier in accordance with one or more embodiments.

FIGS. 5A and 5B illustrate utilizing a GPU of a computing device to generate a digital stroke in accordance with one or more embodiments.

FIG. 6 illustrates acts in a step for deforming bristles of a dynamic digital brush utilizing a digital cage and acts in a step for spreading the deformed bristles based on the pressure amount in accordance with one or more embodiments.

FIG. 7 illustrates a schematic diagram of a brush deformation system in accordance with one or more embodiments.

FIG. 8 illustrates a schematic diagram of an exemplary environment in which the brush deformation system may be implemented in accordance with one or more embodiments.

FIG. 9 illustrates a flowchart of a series of acts for generating a digital paint stroke using a digital cage in accordance with one or more embodiments.

FIG. 10 illustrates a flowchart of a series of acts for generating a digital paint stroke using a bristle spreading modifier where the digital paint strokes reflect individual bristles of digital brushes in accordance with one or more embodiments.

FIG. 11 illustrates a block diagram of an exemplary computing device for implementing one or more embodiments of the present disclosure.

### DETAILED DESCRIPTION

This disclosure describes one or more embodiments of a brush deformation system that quickly and efficiently models bristles in a digital brush to generate a digital paint stroke. In particular, in one or more embodiments, the brush deformation system employs digital cage-based modeling to control dynamics and deformation of bristles of a digital brush with significantly reduced computational costs. Further, the brush deformation system can model accurate and intuitive bristle splitting in a realistic manner in response to user drawing input. Moreover, the brush deformation system can significantly reduce computational costs needed to render digital strokes by efficiently leveraging graphical processing unit (GPU) functionality.

To illustrate, in one or more embodiments, the brush deformation system utilizes a digital cage surrounding bristles of a digital brush for fast brush shape modeling. The brush deformation system then determines bristle shape based on deformations of the digital cage by applying deformation weights to individual bristles. This approach allows for heterogeneous stiffness in the digital cage for more accurate determination of realistic brush deformation at low computational cost.

Furthermore, the brush deformation system can model brush tip splitting resulting from pressure applied to the digital brush. In particular, the brush deformation system can determine and apply a dynamic bristle spreading modifier that varies based on vertical location within the digital brush and/or downward pressure applied to the digital brush. Accordingly, the brush deformation system can model not only deformations in the brush resulting from bends, twists, and turns as bristles interact with the digital canvas, but also based on splitting that results from downward pressure along a longitudinal axis of the digital brush.

Moreover, the brush deformation system can also efficiently render individual digital paint strokes in one GPU shader pass. In particular, the brush deformation system can analyze individual pixels in parallel at the GPU to generate a sweep map in one single render pass utilizing a single GPU draw call. This approach utilizes GPU processing power more efficiently and quickly, thus resulting in faster and more efficient rendering of digital paint strokes.

As recently mentioned, the brush deformation system can employ a digital cage to model dynamic deformation of bristles of a digital brush. Specifically, in one or more embodiments, the brush deformation system generates a digital cage that encompasses bristles of the digital brush, including bristle vertices located along each bristle from the base to the tip of the digital brush. In particular, the brush deformation system can generate a digital cage made up of cells where each cell includes a subset of bristle vertices corresponding to portions of bristles that pass through the cell.

In addition, the brush deformation system can determine deformation weights for each bristle relative to the digital cage. For example, the brush deformation system can determine deformation weights (e.g., skinning weights) for each bristle vertex based on the spatial location of the bristle vertex relative to the cell in which the bristle vertex is located. The brush deformation system can use the deformation weight to easily and realistically deform bristles of the digital brush based on deformations to the digital cage resulting from drawing input.

As mentioned above, in one or more embodiments, the brush deformation system can further realistically split bristles of the digital brush based on drawing input. For instance, based on a pressure amount and/or change in position of the digital brush reflected in drawing input, the brush deformation system can dynamically spread the bristles of the digital brush. In particular, in one or more embodiments, the brush deformation system determines a bristle spreading modifier based on a bristle vertex's vertical location on the bristle, the pressure amount of the drawing input, and/or user-specified spreading factors (e.g., a selected brush stiffness or a spreading tolerance). The brush deformation system can then modify (e.g., spread) one or more bristle vertices based on the determined bristle spreading modifier (e.g., by moving the bristles away from a cross-sectional axis of the digital brush in accordance with the bristle spreading modifier).

Upon deforming the digital brush using the digital cage and/or spreading bristles of the digital brush, the brush deformation system can generate a stroke on a digital canvas using the digital brush. To illustrate, in one or more embodiments, the brush deformation system determines a first bristle imprint at a first point in time and a second bristle imprint at a second point in time. Based on the two bristle imprints, the brush deformation system can render a digital stroke.

As mentioned above, the brush deformation system can render the digital stroke by providing a single call to the GPU. In particular, the brush deformation system can utilize computer processing unit (CPU) to identify imprints of a digital brush and provide this data, along with color and texture information, to the GPU in a single drawing call. The brush deformation system can then utilize the GPU to interpolate the geometry of the stroke (between the first point in time and the second point in time) and generate a sweep map by analyzing the color of each pixel in the stroke in parallel. In this manner, the brush deformation system can leverage the architecture of the GPU to more efficiently draw painting strokes.

As previously mentioned, the brush deformation system provides many advantages and benefits over other conventional/modern systems. For example, the brush deformation system provides realistic digital brushes that enable users to create aesthetic stroke patterns based on natural and intuitive brush movements and manipulations. Further, the brush deformation system can apply a digital cage-based model and tip spreading control to a wide scope of brush types and styles by changing the bristle layout and/or digital cage structure.

In addition, the brush deformation system provides these and other benefits while reducing computer memory and/or computational resources. Indeed, by employing a digital cage, the brush deformation system can model an increased number of bristles in a digital brush without a significant increase in computational costs. Rather, the brush deformation system can accurately simulate hundreds or thousands of bristles while maintaining a low processing load. Accordingly, the brush deformation system enables users to utilize more realistic brushes with any number or configuration of bristles.

As a further benefit, the brush deformation system can also efficiently leverage GPU architecture to quickly render digital strokes. In particular, as mentioned above, the brush deformation system can render pixels of a digital stroke in parallel utilizing a single draw call to the GPU (e.g., rather than redundant calls to draw overlapping stamps within a stroke). Similarly, because of the savings in both memory and processing resources, the brush deformation system provides increased flexibility by operating on a variety of computing devices. For example, unlike conventional/modern systems discussed above, many mobile client devices can efficiently implement the brush deformation system.

As illustrated by the foregoing discussion, the present disclosure utilizes a variety of terms to describe features and advantages of the brush deformation system. For reference, additional detail is now provided regarding the use of these terms. For example, as used herein, the term “electronic document” refers to an electronic or digital file. In particular, the term “electronic document” includes a digital file capable of storing, portraying, recording, or displaying a digital stroke. For example, an electronic document can include electronic files in the form of an image file, a vector-based file, raster-based file, a portable document file (PDF), an e-mail file, a word-processing document, or a web page. Moreover, as mentioned above, an electronic document can include a digital canvas.

As used herein, the term “digital canvas” refers to a digital representation of a surface (e.g., a surface for painting or drawing). In particular, the term “digital canvas” includes a persistent digital media where a user can create an art object. For example, a digital canvas can include a shape, element, field, or another digital surface that can receive and/or portray a drawing (e.g., a digital stroke). To illustrate, in one or more embodiments, user draws or paints digital strokes using a digital brush on a digital canvas. In addition, a user can edit, share, copy, print, or delete portions of a digital canvas, or the digital canvas as a whole. Often, a digital canvas has one or more properties, such as canvas dimensions and print/display resolution.

As used herein, the term “digital stroke” (or “digital paint stroke,” “digital drawing stroke,” or simply “stroke”) refers to a digital representation of a drawing. In particular, the term digital stroke includes a digital visual representation of all or a portion of a digital drawing (i.e., a digital painting). A digital stroke can include any shape (e.g., a straight line, curved line, and/or combination of curves) as determined by input from an input device (e.g., a drawing device).

Moreover, as used herein, the term “digital brush” refers to a virtual tool for generating a digital stroke. In particular, a digital brush includes a three-dimensional digital model comprising a plurality of bristles for generating a digital stroke (e.g., painting a digital stroke). For example, a digital brush can include a three-dimensional model with bristles that extend from a base of the digital brush (e.g., the bottom of a digital handle) to a tip of the digital brush. A digital brush can include any number of bristles, in any arrangement, and can be any bristle length. In various embodiments, the digital brush mirrors (in a digital environment) the movement and action of a drawing device (in a real-world environment).

As used herein, the term “bristle” refers to a portion of a digital brush capable of applying color to a digital canvas. In particular, the term “bristle” includes a part of a digital brush that contacts the digital canvas when generating a digital stroke. For example, a bristle includes a deformable (e.g., flexible) line that transfers virtual paint from the digital brush to the digital canvas via strokes. A bristle can be any size, length, thickness, hardness, and/or shape (e.g., round, flat, bright, filbert, fan, angle, mop, rigger, liner, dagger, or scripts). In addition, a bristle can mimic various real-world materials and can be flagged or unflagged. When multiple bristles contact the digital canvas, the digital brush creates a bristle imprint on the digital canvas, as further described below.

A bristle can include bristle vertices. As used herein, the term “bristle vertex” refers to a set point on a bristle. In particular, a bristle vertex includes a point on a bristle utilized to model movement of the bristle and/or and transfer of colors (e.g., paint) from the bristle. A bristle can include multiple bristle vertices (i.e., any number of bristle vertices). For example, a bristle can include a root bristle vertex on one end of the bristle (e.g., located near, or attached to, the base of the digital brush). A bristle can also include a tip bristle vertex on the other end of the bristle (e.g., located at or near the tip of the digital brush). In addition, a bristle can include intermediary bristle vertices between the root bristle and the tip bristle. When a bristle vertex contacts a pixel on a digital canvas, the bristle vertex can transfer color to the digital canvas.

As mentioned above, the brush deformation system can generate a digital cage that encompasses bristles in a digital brush. As used herein, the term “digital cage” refers to a lattice structure that fully or partially encompasses bristles of the digital brush. In particular, the term “digital cage” includes a deformable three-dimensional structure that houses bristles from the base to the tip of a digital brush. As described below, in one or more embodiments, the brush deformation system deforms a digital cage based on drawing input from a drawing device. In addition, in one or more embodiments, a digital cage is made up of cells (e.g., a set of cells smaller than the number of bristle vertices in the digital brush). For example, a digital cage can include a 2×1×2 (width, depth, height) grid of cells or a 3×2×3 grid of cells. A digital cage can include any number or arrangement of adjacent cells. Further, a digital cage can correspond to a variety of shapes to accommodate different brush patterns.

As used herein, the term “cell” refers to a three-dimensional digital shape (e.g., a cube) that forms a portion of a digital cage. In particular, the term “cell” includes a part of a digital cage that has a portion of some or all of the bristles of a digital brush. For example, a cell includes a three-dimensional cube that encompasses a subset of bristle vertices from a subset of bristles in a digital brush. Indeed, each portion of a bristle that passes through a cell can include one or more bristle vertices located within the cell. In addition, each cell can include cell vertices, such as corners of the cell where three or more edges meet.

As mentioned above, based on the spatial location of a bristle vertex within a cell, the brush deformation system can determine a deformation weight. As used herein, the term “deformation weight” refers to a measure of influence that a cell (or cell vertex) has on a bristle vertex. In particular, deformation weight includes a measure of deformation (or movement, force, or energy) that a bristle vertex will experience based on deformation of a corresponding cell (or cell vertex). For example, in one or more embodiments, a deformation weight includes a skinning weight.

As used herein, the term “drawing device” refers to any device that generates drawing input. In particular, the term “drawing device” includes a pressure sensitive device that generates drawing input in connection with drawing a stroke. Examples of drawing devices include a stylus, pressure sensitive screen, mouse, or another input device. In various embodiments, a drawing device allows a user to mimic movement/pressure of a real paintbrush, the drawing device detects the movement/pressure, and generates corresponding drawing input. In addition, a drawing device can include a touch-sensitive device, such as a touchscreen on a tablet, that generates drawing input. In various embodiments, the drawing device is a pressure-sensitive device that provides an indication of a pressure amount applied to the drawing device.

As used herein, the term “drawing input” refers to user input from a drawing device. In particular, drawing input includes user input based on movement, pressure, or position of a drawing device. Drawing input can include data generated by a variety of user interactions, including mouse press, mouse drag, mouse scroll, and mouse release events; stylus press, stylus drag, and stylus release events; and/or touchscreen press, touchscreen drag, touchscreen pinch, and touchscreen release events. For example, drawing input can include pressure of a drawing device at a particular angle against a real-world surface that indicates a corresponding pressure of the digital brush at a corresponding angle against a digital canvas.

As used herein, the term “bristle spreading modifier” refers to a measure of horizontal displacement due to pressure corresponding to a digital brush. In particular, the term “bristle spreading modifier” includes a measure of horizontal displacement of a bristle vertex at a vertical location of a digital brush due to downward pressure against the tip of the digital brush. In particular, the term “bristle spreading modifier” refers to a multiplier that increases the horizontal distance of a bristle vertex from a cross-sectional axis of a digital brush.

As mentioned above, when a digital brush contacts the digital canvas, the bristles of the digital brush can leave an imprint on the digital canvas as part of a stroke. As used herein, the terms “bristle imprint” refers to a representation of contact bristle vertices (i.e., a collection of bristle vertices of the digital brush that contact a digital canvas). In particular, the term “bristle imprint” includes a representation of contact bristle vertices at a particular time and/or particular location during a stroke. For example, a bristle imprint projects or stamps color values from contact bristle vertices to pixels of the digital canvas.

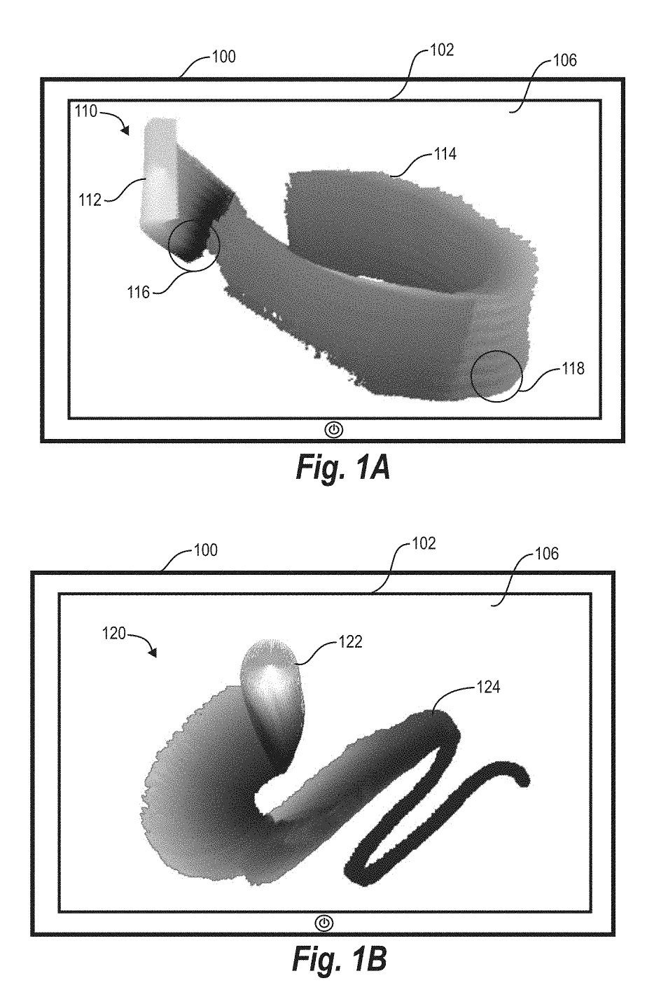

Referring now to the figures, FIGS. 1A and 1B illustrate results of the brush deformation system. In particular, FIGS. 1A and 1B illustrate digital strokes generated via a computing device in accordance with one or more embodiments. Additional detail regarding how the brush deformation system deforms bristles of digital brushes and renders digital strokes is provided with respect to subsequent figures.

As illustrated, FIG. 1A shows a computing device 100 with a display screen 102. The display screen 102 (via a graphical user interface) portrays a first painting 110 of a rectangular digital brush 112 that the brush deformation system utilizes to generate a digital stroke 114 on a digital canvas 106. Moreover, FIG. 1B shows the computing device 100 and the display screen 102 portraying a second painting 120 of a round digital brush 122 that the brush deformation system utilizes to generate the second digital stroke 124 on the digital canvas 106. While only the bristles of the rectangular digital brush 112 and the round digital brush 122 are displayed in FIGS. 1A and 1B, the digital brushes can include additional parts (not visible in FIGS. 1A and 1B), such as a handle and a base. In some embodiments, the brush deformation system displays the digital brush base and/or the handle, along with the bristles via the display screen 102 (and corresponding user interface).

As illustrated in FIG. 1A, the rectangular digital brush 112 is deformed at the end of the first digital stroke 114 (i.e., the tips of the bristles are bending in response to contact and/or pressure with the digital canvas 106). Specifically, the brush deformation system receives drawing input from a drawing device (e.g., a stylus or a touchscreen) controlled by a user that moves the digital rectangular digital brush 112 against the digital canvas 106. In response, the brush deformation system deforms the bristles against the digital canvas 106 at the end of the first digital stroke 114. Further, in response to drawing input lifting the rectangular digital brush 112 away from the digital canvas 106 (e.g., indicating a lesser amount of pressure), the brush deformation system relaxes the deformation of the bristles such that only a portion of the bristles are in contact with the digital canvas 106 at the end of the first digital stroke 114.

As also shown in the first painting 110, the bristles of the rectangular digital brush 112 have a wavy bristle groove pattern 116 along the bristles of the rectangular digital brush 112. As a result, the first digital stroke 114 includes corresponding bristle grooves 118 that match the contours of bristles contacting the digital canvas 106. However, in other portions of the first digital stroke 114 (e.g., near the end of the first digital stroke 114), the corresponding bristle grooves are not present. For example, when a user applies pressure to the drawing device, the brush deformation system deforms the bristles of the rectangular digital brush 112 such that the waves are less pronounced or flat against the digital canvas.

Similarly, as shown in FIG. 1B, the round digital brush 122 includes a number of bristles that naturally converge at the tip of the brush. As shown, at the beginning of the second digital stroke 124, the width of the paint gradually increases. For example, the drawing input indicates a gradual increase in pressure amounts from a drawing device. In response, the brush deformation system gradually deforms the round digital brush 122 to increase the width of the bristle contact. In addition, as the user flattens the angle of the drawing device near the end of the second digital stroke 124, the brush deformation system shifts from deforming the bristles at the tip of the round digital brush 122 to the sides of the brush.

As shown in FIGS. 1A and 1B, the brush deformation system enables users to generate realistic digital paint strokes. Indeed, as shown in FIGS. 1A and 1B, the brush deformation system allows users to generate paint strokes that reflect contact between individual bristles of a digital brush and a digital canvas. Accordingly, the brush deformation system can generate complex, realistic digital paint strokes that reflects twists, bends, splits, and other deformations of individual bristles, similar to real-world painting. Furthermore, the brush deformation system can generate digital strokes that reflect stabbing, layering, scumbling, or other complex painting effects.

Although FIGS. 1A and 1B illustrate the digital strokes 114, 124 as including all portions of a digital painting, the term digital stroke can include a portion of a digital painting. For instance, in one or more embodiments, a digital stroke can include an entire line (e.g., path) defined by a starting point (e.g., a point at which the user engages an input device), an ending point (e.g., a point at which the user disengages the input device), and a path between the starting point and the ending point. In some embodiments, a digital stroke includes only a portion of such a path. For instance, in various embodiments, the points in a digital stroke are based on pre-determined (and/or user-defined) time intervals (e.g., creating a digital stroke at each half-second interval). In these embodiments, digital strokes can vary in length based on the speed that a digital brush moves.

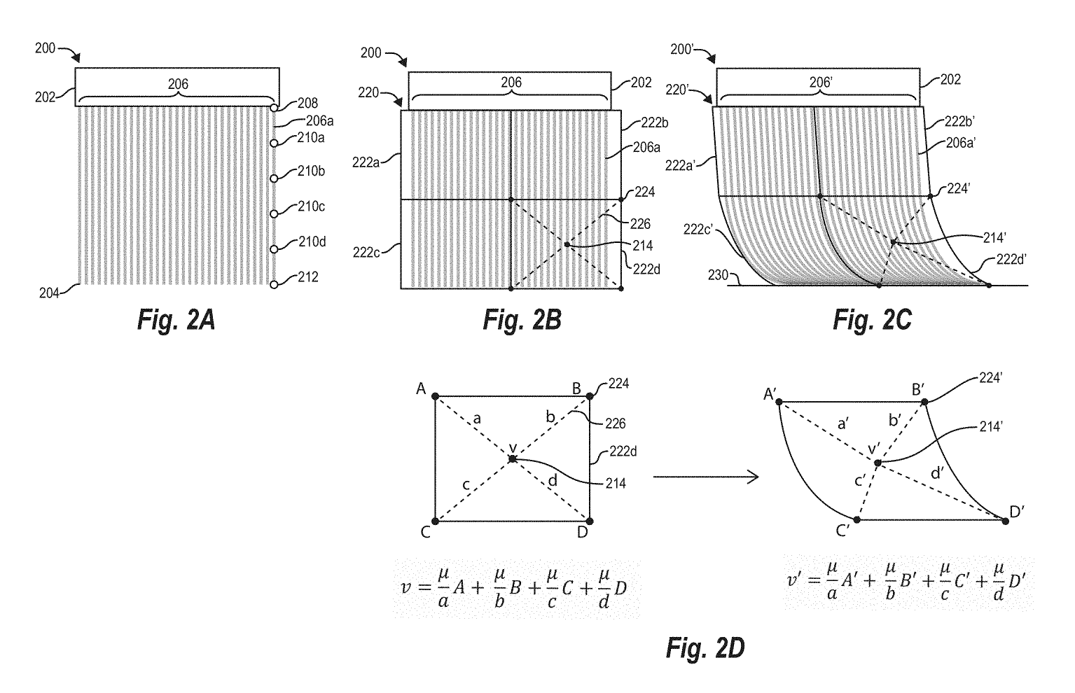

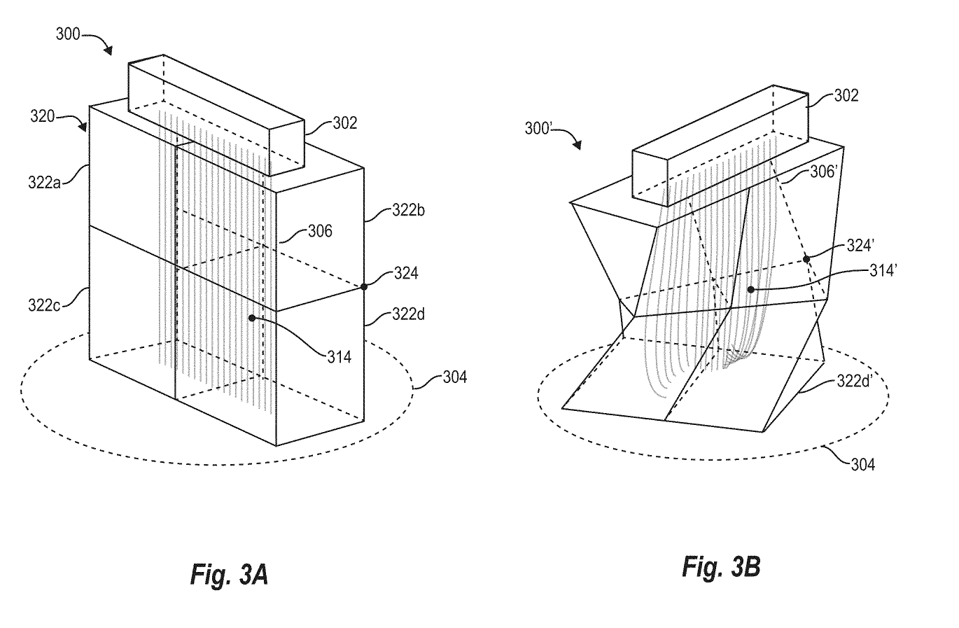

Turning to FIGS. 2A-2D, additional detail regarding how the brush deformation system deforms bristles of the digital brush will now be provided. In particular, FIGS. 2A-2D illustrate a two-dimensional representation of deforming bristles in a digital brush using a digital cage and a deformation weight. For explanatory purposes, FIGS. 2A-2D illustrate a two-dimensional representation of a digital brush and digital cage while FIGS. 3A-3B below provides further explanation in a three-dimensional context.

Specifically, FIG. 2A shows a digital brush 200 that includes a brush base 202 and a brush tip 204. In addition, the digital brush 200 includes a plurality of bristles 206. Each of the bristles 206 include multiple bristle vertices. For example, as shown, a first bristle 206a includes a root bristle vertex 208 that is located at or near the brush base 202, a tip bristle vertex 212 located at or near the brush tip 204, and intermediary bristle vertices 210a-d. The brush deformation system can determine deformation of the bristles 206 and corresponding bristle vertices in response to drawing input to model transfer of color between the digital brush 200 and a digital canvas.

While a particular digital brush 200 with particular characteristics is shown, the brush deformation system can utilize a digital brush with a variety of different characteristics. For example, the digital brush 200 can include any number of bristles (e.g., 1000 bristles), configured in any arrangement or pattern (e.g., square, pointed, or tapered), and at any length. Moreover, the brush deformation system can model the bristles 206 by attaching them to the surface of the brush base 202 and/or extending them into the brush base 202. While a model of a large brush base 202 is illustrated, in one or more embodiments, the brush base 202 is modeled as a flat line or three-dimensional plane that secures at least one end of the bristles. In some embodiments, no brush base is present, and a brush handle functions as the brush base by securing the bristle to a fix position at one end.

Furthermore, the brush deformation system can generate the bristle vertices 208-212 in a variety of arrangements. In relation to FIG. 2A, the brush deformation system evenly distributes the intermediary bristle vertices 210a-d across the first bristle 206a between the brush tip 204 (e.g., the tip bristle vertex 212) and the brush base 202 (e.g., the root bristle vertex 208). The brush deformation system can also distribute the bristle vertices 210a-d in a different arrangement (e.g., concentrated more heavily at one end of a bristle, such as near the brush tip 204). In addition, while a few bristle vertices are shown for ease of explanation, the digital brush 200 can include additional bristle vertices (e.g., 10-20+ per bristle). In some embodiments, the number of bristle vertices is proportional to the length of a bristle. In addition, in various embodiments, regardless of a bristle's length, the brush deformation system can enforce a minimum number of bristle vertices per bristle.

In one or more embodiments, the bristles 206 on the digital brush 200 are the same length and the bristle vertices align with each other across bristles. In some embodiments, the bristles 206 are different lengths and/or bristle vertices are placed at varying locations. To illustrate, if the bristles in the digital brush 200 are in a fan shape, where center bristles are shorter than edge bristles, the brush deformation system can equally space the bristle vertices on each bristle. Alternatively, the brush deformation system can place bristle vertices at set vertical distances (e.g., every 5 pixels) such that longer bristles include more intermediary bristle vertices 210a-d than the shorter bristles.

As mentioned above, the brush deformation system can utilize a digital cage to model deformation of a digital brush. For example, FIG. 2B illustrates a digital cage 220 around the bristles 206 of the digital brush 200. In particular, the digital cage 220 comprises a plurality of cells 222a-222d forming a 2×2 (width×height) lattice structure. Moreover, as illustrated, the digital cage 220 encompasses the bristles 206 and the cells 222a-222d each encompass a portion of the bristles 206 and a subset of bristle vertices. The brush deformation system can utilize the digital cage 220 and the corresponding cells 222a-222d to efficiently model deformation of the digital brush 200.

For instance, in one or more embodiments, the brush deformation system determines deformation weights for bristle vertices within cells of a digital cage and utilizes the deformation weights to map deformations of the digital cage to deformations of individual bristles. Specifically, in one or more embodiments, the brush deformation system determines deformation weights for bristle vertices based on distances from cell vertices of a digital cage.

For example, as shown in FIG. 2B, each of the cells 222a-d in the digital cage include cell vertices. Further, the cell 222d in the digital cage 220 shows a cell vertex 224 (i.e., one of four vertices in the corners of the cell 222d). Moreover, as shown, the cell 222d encompasses the bristle vertex 214.

Based on the position of the cell vertex 224 (and/or other cell vertices of the cell 222d) and the spatial location of the bristle vertex 214, the brush deformation system determines a deformation weight for the bristle vertex 214. To illustrate, the brush deformation system determines a distance 226 between the bristle vertex 214 and the cell vertex 224. The brush deformation system then utilizes the distance 226 to determine a deformation weight. In particular, the brush deformation system determines a deformation weight utilizing the following Equation 1:

$$w = \frac{μ}{b} \qquad ( 1 )$$

As shown in Equation 1, w is the deformation weight, μ is a deformation constant, and b is the distance 226 between the bristle vertex 214 and the cell vertex 224. In this manner, the brush deformation system can determine a deformation weight corresponding to the bristle vertex 214 and the cell vertex 224.

In addition, in one or more embodiments, the deformation constant μ normalizes the deformation weights for the bristle vertex 214 (e.g., the deformation weights collectively sum to one). Specifically, the deformation constant can normalize the deformation weights such that they sum to 1. Accordingly, deformation constant μ can be a function of the distances between the bristle vertex 214 and the cell vertices. For example, if the brush deformation system determines deformation weights for a bristle vertex having four distances (i.e., a, b, c, d) corresponding to four cell vertices (i.e., A, B, C, D), then the deformation constant μ can utilizing the following Equation 2:

$$μ = 1 \text{/} ( \frac{1}{a} + \frac{1}{b} + \frac{1}{c} + \frac{1}{d} ) such that \frac{μ}{a} + \frac{μ}{b} + \frac{μ}{c} + \frac{μ}{d} = 1 \qquad ( 2 )$$

In one or more embodiments, the brush deformation system determines a deformation weight for each cell vertex/bristle vertex pair within a cell. For example, in relation to FIG. 2B, the brush deformation system measure distances between the bristle vertex 214 and the other cell vertices of the cell 222. Moreover, the brush deformation system generates a deformation weight specific to the bristle vertex 214 for each of the cell vertices.

As mentioned, the brush deformation system can identify deformation weights for each bristle vertex of each bristle. For instance, the brush deformation system determines the spatial location of each bristle vertex relative to the cell vertices in which the bristle vertex is located. Based on the spatial location of each bristle vertex and the corresponding cell vertices, the brush deformation system can determine deformation weights for the bristle vertex.

Although FIG. 2B illustrates a particular exemplary embodiment of the digital cage 220 and the cells 222a-22d, the brush deformation system can utilize a variety of different digital cages with different arrangements or features. For example, in various embodiments, the bristles extend outside of the digital cage 220, such as above the digital cage 220 into the brush base 202. In some embodiments, the digital cage 220 is larger and encompasses the brush base 202 and/or other parts of the digital brush 200 not illustrated (e.g., portions of the brush handle).

Similarly, although the digital cage 220 in FIG. 2B is made up of a 2×2 (width×height) grid of cells, in one or more embodiments, the brush deformation system generates a digital cage that includes a different lattice structure (e.g., 1×2, 2×1, 3×2, 3×3, etc.). In addition, the cells can vary in size and shape. Moreover, each row/column can have varying numbers of cells. Indeed, the brush deformation system can generate a digital cage that includes cells of various polygonal shapes (e.g., pentagons or hexagons) that combines to form a solid digital cage. For example, the cells can be triangular in shape. Further, the triangles can vary in size within the same digital cage.

Furthermore, although FIG. 2B illustrates generating deformation weights based on cell vertices in a particular location (e.g., the corners of a cell), the brush deformation system can determine deformation weights based on cell vertices in a variety of locations. For instance, the brush deformation system can utilize cell vertices at the center of an edge of the cell or utilize cell vertices spaced along the edges of the cell (e.g., at pre-defined intervals).

As mentioned above, deformation weights can indicate a measure of influence that the deformation of a cell vertex has on a corresponding bristle vertex. Indeed, in one or more embodiments, the brush deformation system determines deformation of a digital cage (e.g., deformation of individual cell vertices) and then utilizes the deformation weights together with the deformed digital cage to determine modified locations of individual bristle vertices.

For example, as shown in FIG. 2C, the brush deformation system deforms the bristles 206 of the digital brush 200 based on a deformed digital cage 220′. In particular, FIG. 2C shows a deformed digital brush 200′ that includes deformed bristles 206′ attached to the brush base 202 included the deformed bristle 206a′. In addition, FIG. 2C shows a deformed digital cage 220′ having one or more deformed cells 222a′-d′ including a deformed cell 222d′. For instance, in response to drawing input, the brush deformation system moves the digital cage 220 toward a digital canvas 230, which pressures the bottom of the digital cage 220 and results in the brush deformation system creating the deformed digital cage 220′. Upon generating the deformed cage 220′, the brush deformation system applies deformation weights to generate the deformed bristles 206′.

As just mentioned, in response to drawing input, the brush deformation system generates a deformed the digital cage 220′. The brush deformation system can utilize a variety of methods to deform a digital cage. In one or more embodiments, the brush deformation system deforms the digital cage utilizing a shape matching method. In particular, the brush deformation system models the digital cage as a soft body and each cell in the digital cage as a second order element, such that each cell has its own quadratic deformation. For instance, in one or more embodiments, the brush deformation system models deformation of digital cages utilizing the approach for deforming three-dimensional objects described by Matthias Müller, Bruno Heidelberger, Matthias Teschner, and Markus Gruss in Meshless Deformations Based on Shape Matching, ACM Transactions on Graphics, SIGGRAPH 2005 Proceedings, 24(3):471-78 (2005), which is incorporated herein by reference in its entirety. In one or more embodiments, the brush deformation system employs other types of analysis to determine deformation of a digital cage (e.g., linear, cluster-based, or plasticity-based).

Accordingly, as shown, the brush deformation system can individually deform each of the cells 222a-d to create the deformed digital cage 220′. As illustrated, the drawing input will uniquely affect each cell based on the cell's spatial location with the digital cage. In addition, a deformed cell can influence the deformation of one or more adjacent cells in a digital cage, further resulting in unique cell deformation shapes.

In one or more embodiments, the brush deformation system deforms cells near the brush tip to a greater extent than the cells near the brush base. To illustrate, the deformed cells 222a′, 222b′ in the top row, are each less deformed compared to the deformation of the deformed cells 222c′, 222d′ in the bottom row. Although such deformations can occur as a result of different pressures applied to the tip of the digital brush 200, in some embodiments, the brush deformation system also models the digital cage to allow for greater flexibility (e.g., less stiffness) of cages nearer to the brush tip. Indeed, by modeling cells based on their own individual quadratic deformations, the brush deformation system can apply different stiffness in simulating deformation.

For example, in one or more embodiments, the brush deformation system applies a stiffness or rigidity factor to each cell in the digital cage based on the cell's spatial location within the digital cage. For instance, the brush deformation system applies a large rigidity factor to cells adjacent to the brush base 202 and decreases the rigidity factor as the spatial location of cells move away from the brush base toward the brush tip.

By applying a variable rigidity factor, the brush deformation system can more accurately model behavior of a tangible paintbrush. Indeed, tangible paintbrushes tend to have greater flexibility at the tip than the base. Applying a larger rigidity factor to cells near the brush base 202 will prevent these cells from deforming to the same extent as the cells located near the brush tip, which are assigned a lower rigidity factor.

In some embodiments, the brush deformation system determines a rigidity factor (e.g., based on the number, density, and flexibility of bristles in a cell of a digital brush). For example, if bristles are densely grouped and/or fixed to the brush base 202, the brush deformation system can apply a stricter rigidity factor. Likewise, if bristles are loosely grouped and/or free-flowing (i.e., unattached), the brush deformation system can apply a relaxed rigidity factor to allow for greater bristle deformation.

The brush deformation system can model a variety of different deformations based on interaction between a digital brush and a digital canvas. Indeed, drawing input from a drawing device can indicate angle, tilt, twist, orientation, and movement of a digital brush that influences how the brush deformation system deforms a digital cell. For example, drawing input that includes a combination of brush angle, brush twist, and applied pressure may reveal an uneven collision between the tip of the digital brush and the digital canvas. As a result, the brush deformation system can apply uneven pressure to cells along the bottom of the digital cage, resulting in an uneven deformation of the digital cage and individual cells within the digital cage. In this manner, the brush deformation system can model bending, twisting, or other deformations resulting from different interactions between a digital brush and a digital canvas.

As previously mentioned, upon deforming a digital cage, the brush deformation system can also deform bristles of a digital brush based on the deformed digital cage. For instance, in one or more embodiments, the brush deformation system uses the deformation weights for a bristle vertex to relocate the bristle vertex within the deformed digital cage, such that the relative spatial location of the bristle vertex is maintained even after the digital cage deformation.

For example, FIG. 2C illustrates deforming the bristles 206 using the deformed digital cage 220′. Specifically, the brush deformation system applies the deformation weight previously determined for the bristle vertex 214 to the deformed cell vertex 224′ to determine a spatial position for the deformed bristle vertex 214′. More specifically, the brush deformation system applies deformation weights to all the deformed vertices of the deformed cell 222d′ to determine the deformed bristle vertex 214′.

Utilizing this approach, the brush deformation system can determine deformed locations for all bristle vertices in the digital brush 200. In particular, the brush deformation system can determine deformed cell vertices, apply deformation weights specific to each bristle vertex to the deformed cell vertices, and determine a new spatial location for each bristle vertex. As mentioned above, applying deformation weights is computationally insignificant. Accordingly, the brush deformation system can determine the location of bristle vertices for thousands of bristles in a digital brush without significant expenditure of computational resources.

Upon modifying the spatial location of bristle vertices, the brush deformation system can realign the bristles of the digital brush 200 to reconnect and/or pass through corresponding bristle vertices. Thus, as shown in FIG. 2C, realigning the bristles 206 based on the deformed digital cage 220′ results in deformed bristles 206′ and a deformed digital brush 200′.

In one or more embodiments, the brush deformation system utilizes a mathematical algorithm to apply the deformation weights specific to each bristle vertex. For example, FIG. 2D illustrates an algorithm for applying deformation weights in accordance with one or more embodiments. In particular FIG. 2D illustrates an expanded view of the cell 222d and the deformed cell 222d′. The cell 222d includes four cell vertices labeled A-D and corresponding distances (i.e., labeled a-d) between the bristle vertex 214 and each of the four cell vertices. Similarly, the deformed cell 222d′ includes four deformed cell vertices labeled A′-D′ and corresponding distances (i.e., labeled a′-d′) between the bristle vertex 214 and each of the four deformed cell vertices.

As also shown, the bristle vertex 214 moves from a resting spatial location (i.e., v) in the cell 222d to a modified spatial location (i.e., v′) in the deformed cell 222d′. As mentioned above, the brush deformation system determines the modified spatial location of the bristle vertex based on one or more deformation weights.

Equation 3, shown below, provides an example of the brush deformation system determining deformation weights for the bristle vertex 214 based on the cell vertices of the cell 222d.

$$v = \frac{μ}{a} A + \frac{μ}{b} B + \frac{μ}{c} C + \frac{μ}{d} D \qquad ( 3 )$$

As shown in Equation 3, the spatial location of v (i.e., the bristle vertex 214) is based on a combination of a deformation constant μ, the cell vertices A-D, and the corresponding distances (i.e., a-d) between the bristle vertex 214 and each of the cell vertices. Depending on the dimensions of the cell, the coordinates of the cell vertices A-D (i.e., coordinates of the cell vertices) can be stored as a vector, a matrix, or another data structure. Similarly, the corresponding distances can include n-dimensional distances that match to the dimensions of the cell (g two- or three-dimensional).

As described above, in one or more embodiments, the brush deformation system determines the deformation weight for the bristle vertex 214 by dividing the deformation constant μ by one of the corresponding distances. For instance, as described above, the deformation weight with respect to cell vertex A is μ/a. Similarly, the brush deformation system can determine additional deformation weights for the bristle vertex 214 based on the remaining cell vertices of the cell 222d. In addition, the brush deformation system can determine deformation weights for one or more additional vertices in the cell.

As mentioned above, the brush deformation system can use the deformation weights of bristle vertices to quickly deform a large number of bristles of a digital brush. To demonstrate, Equation 4 in FIG. 2D shows an example of how the brush deformation system applies the deformation weights previously determined for the bristle vertex 214 to identify the modified spatial location of the deformed bristle vertex 214′ (i.e., v′).

$${v}^{′} = \frac{μ}{a} {A}^{′} + \frac{μ}{b} {B}^{′} + \frac{μ}{c} {C}^{′} + \frac{μ}{d} {D}^{′} \qquad ( 4 )$$

As shown in Equation 4, the deformed cell vertices are labeled A′-D′. Further, as shown, the brush deformation system employs the same deformation weights (i.e., μ/a, μ/b, μ/c, and μ/d) described above. Thus, by applying the deformation weights of the bristle vertex 214 to the deformed cell vertices A′-D′, the brush deformation system determines the modified spatial location of the deformed bristle vertex 214′, labeled as v′. As shown, the brush deformation system places the deformed bristle vertex 214′ at a new spatial location with new distances (i.e., a′-d′) to each of the deformed cell vertices A′-D′.

As mentioned above, the brush deformation system can employ the deformed digital cage 220′ to accurately and quickly deform corresponding bristles. In particular, Equation 4 is computationally inexpensive to calculate and apply. Accordingly, the brush deformation system can model the digital brush 200 utilizing Equation 4 to efficiently and accurately model thousands of bristles on a digital brush without a significant increase in computational costs.

While FIGS. 2A-2D illustrate a two-dimensional representation of deforming bristles, as mentioned above, the brush deformation system frequently utilizes three-dimensional models of digital brushes. For example, FIGS. 3A and 3B illustrate a three-dimensional representation of deforming bristles in a digital brush using a digital cage and a deformation weight. To illustrate, FIG. 3A includes a digital brush 300 and a digital canvas 304. The digital brush 300 includes a brush base 302, bristles 306, and a digital cage 320 shown in three-dimensions. FIG. 3A also shows a bristle vertex 314 on one of the bristles 306. For illustrative clarity, FIGS. 3A and 3B illustrate only a single row of bristles 306. The digital brush 300 can include additional rows of bristles and/or a different arrangement of bristles.

As with the previous figures, each of the bristles 306 can include multiple bristle vertices, such as a root bristle vertex, a tip bristle vertex, and intermediary bristle vertices. In addition, bristle vertices on a bristle can be spaced uniformly or unevenly (e.g., more concentrated toward the brush tip). Further, while the bristles 306 appear to terminate at the brush base 302, in some embodiments, the bristles 306 extend into the brush base 302 and/or into a brush handle.

As also shown, the digital cage 320 includes a plurality of cells 322a-d in a 2×1×2 grid (width, depth, height). Other cell configurations are possible, such as a 3×2×3 grid of cells. Additionally, the digital cage 320 encompasses the bristles 306. While the digital cage 320 is shown as being rectangular, the digital cage 320 can include any three-dimensional shape to encompass the bristles 306 (e.g., cylindrical, conical, cubic, rectangular prism, triangular prism, rectangular pyramid, or triangular pyramid). Further, each of the cells 322a-d can include cell vertices. For example, the second cell 322b and the fourth cell 322d share a cell vertex 324.

As explained earlier, the brush deformation system can determine deformation weights for bristle vertices within particular cells. For example, the brush deformation system determines a deformation weight for the bristle vertex 314 based on the spatial location of the bristle vertex 314 and the location of the cell vertex 324. For instance, the brush deformation system identifies the distance between a coordinate of the bristle vertex (e.g., x, y, z coordinates) and a coordinate of the cell vertex 324. Based on the distance and a deformation constant (e.g., μ), the brush deformation system determines one or more deformation weights corresponding to the bristle vertex 314.

The brush deformation system can repeat the process for each of the remaining cell vertices of the fourth cell 322d. For example, the brush deformation system employs the methodology described in relation to Equation 3 (adapted for three-dimensional cells) to determine the deformation weights for the cell vertex 324. More specifically, based on the three-dimensional cell structure shown in FIG. 3A, the brush deformation system can adapt Equation 3 to include eight terms corresponding to the eight cell vertices of the fourth cell 322d.

As described above, the brush deformation system can deform the digital brush 300 based on drawing input. For example, if the drawing input indicates a user is twisting/rotating the digital brush 300 counter-clockwise 180-degrees and applying an amount of downward pressure (e.g., against a real-world surface), the brush deformation system can modify the digital brush 300 from the orientation shown in FIG. 3A to the orientation shown in FIG. 3B. More specifically, the brush deformation system can determine a collision between the digital cage 320 and the digital canvas 304, determine forces (e.g., pressure) applicable to the digital cage 320 (e.g., force applied to the bottom cells of the digital cage 320 due to friction with the digital canvas 304 and force applied to the digital cage 320 due to twisting the digital brush 300). The brush deformation system utilizes the determined forces to deform the digital cage 320 and generate the deformed digital cage 320′.

Moreover, as shown in FIG. 3B, the brush deformation system also re-locates the bristles 306 of the digital brush 300 to correspond to the deformed digital cage 320′. In particular, the brush deformation system generates a deformed brush 300′ with deformed bristles 306′ based on the deformed digital cage 320′. To generate the deformed bristles 306′, the brush deformation system modifies the spatial locations of bristle vertices based on deformation weights, as described previously in connection with Equation 4 (adapted to three-dimensions).

To illustrate, in relation to the bristle vertex 314, the brush deformation system determines deformed cell vertices from the deformed fourth cell 322d′ of the deformed digital cage 320′. The brush deformation system then determines a new spatial location of the deformed bristle vertex 314′ by applying the deformation weights specific to the bristle vertex 314 to the deformed cell vertices of the deformed fourth cell 322d′ (including the deformed cell vertex 324′). Specifically, the brush deformation system applies Equation 4 to each of the deformed cell vertices of the deformed fourth cell 322d′ utilizing the deformation weighs specific to the bristle vertex 314.

In this manner, the brush deformation system can determine the deformed bristles 306′. In particular, the brush deformation system can iterate through each bristle vertex of the bristles 306 and apply deformation weights corresponding to the bristle vertex to corresponding cell vertices. By applying deformation weights specific to each bristle vertex, the brush deformation system can utilize the deformed digital cage 320′ to generate the deformed bristles 306′.

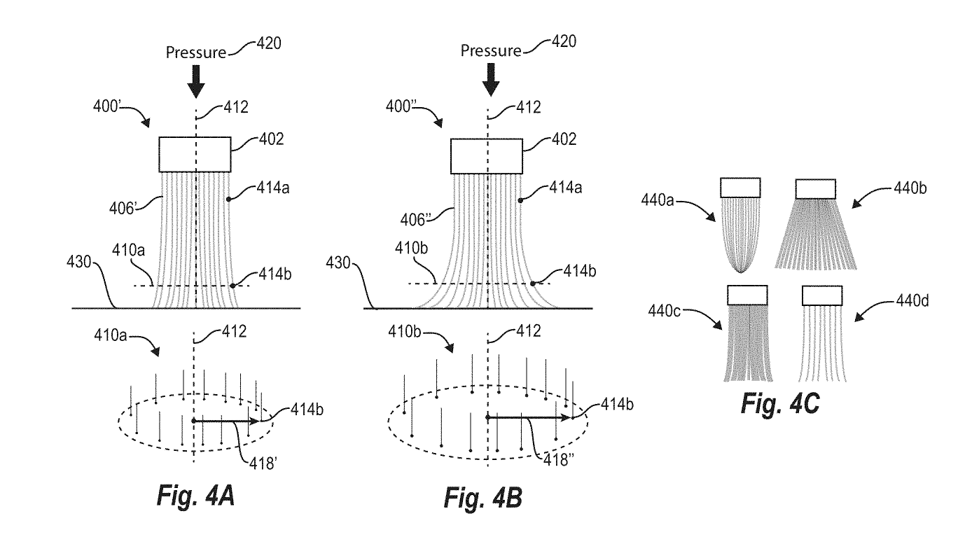

As mentioned above, in one or more embodiments, the brush deformation system models bristle splitting of a digital brush (e.g., splitting resulting from longitudinal pressure) by applying a bristle spreading modifier. For example, the brush deformation system can identify deformed bristles and further modify the deformed bristles by applying a bristle spreading modifier. For instance, FIGS. 4A-4C illustrate a representation of spreading bristles in a digital brush using a bristle spreading modifier in accordance with one or more embodiments. In particular, FIG. 4A illustrates a deformed digital brush 400′ generated by the brush deformation system (e.g., generated utilizing a deformed digital cage, as discussed in relation to FIGS. 2A-3B). Moreover, FIG. 4B illustrates the brush deformation system generating a spread digital brush 400″ by applying bristle spreading modifiers to the deformed digital brush 400′. Moreover, FIG. 4C illustrates various user-selected digital brush types that can influence a bristle spreading modifier.

As mentioned above, the brush deformation system can utilize a bristle spreading modifier to efficiently model splitting effects that result from pressure being applied to the digital brush. As additional context, if an individual presses a real paintbrush (e.g., stabbing) into a canvas, the bristles of the paintbrush may spread out. However, in some cases, modeling bristles with a digital cage may not fully capture this type of deformation. Accordingly, the brush deformation system can apply the bristle spreading modifier to a deformed digital brush to further model brush tip splitting resulting from pressure applied to the digital brush. In this manner, the brush deformation system can model not only deformations in the brush resulting from bends, twists, and turns as bristles interact with the digital canvas, but also based on splitting of individual pixels that results from downward pressure along a longitudinal axis of the digital brush.

As mentioned above, FIG. 4A includes a deformed digital brush 400′ that includes a brush base 402 and deformed bristles 406′. FIG. 4A also includes a digital canvas 430. As mentioned above, the digital brush 400′ in FIG. 4A includes deformations using a digital cage without additional bristle spreading. As an initial matter, the brush deformation system can determine and apply bristle spreading modifiers on a bristle vertex level just as the brush deformation system can modify and deform bristles on a bristle vertex level. For instance, similar to the description above, by modifying the location of a bristle vertex, the brush deformation system can deform and/or influence the overall shape of the bristle on which the bristle vertex lies.

The brush deformation system can spread a bristle vertex, in part, based on vertical distances. For example, in one or more embodiments, the brush deformation system determines a bristle spreading modifier based on the vertical location of a bristle vertex in connection with a pressure amount being exerted to a digital brush. In alternative embodiments, the brush deformation system determines the bristle spreading modifier based on a pressure and another factor (e.g., brush angle, orientation, position, or movement).

To illustrate how vertical distance affects the bristle spreading modifier, FIG. 4A shows a first bristle vertex 414a and a second bristle vertex 414b on the same bristle. The first bristle vertex 414a is located closer to the brush base 402 and the second bristle vertex 414b is located closer to the brush tip and the digital canvas 430. Accordingly, the second bristle vertex 414b has a larger vertical distance from the brush base 402 than the first bristle vertex 414a. Because the second bristle vertex 414b has a larger vertical distance than the first bristle vertex 414a, the brush deformation system utilizes a larger bristle spreading modifier for the second bristle vertex 414b. This results in the second bristle vertex 414b spreading further for the same given pressure.

In some embodiments, the bristle spreading modifier has a default value of 1 for bristle vertices at the brush base 402, and increases as bristle vertices are located further away from the brush base 402 (e.g., as the vertical distance increases). For example, in one or more embodiments, the brush deformation system increases the bristle spreading modifier linearly as the vertical distance increases. Furthermore, in one or embodiments, the brush deformation system increases the bristle spreading modifier according to another function (e.g., exponentially or logarithmically).

Further, when a pressure amount is applied, the bristle spreading modifier can be a function of the vertical distance and pressure amount. Thus, when no pressure amount is present, the bristle spreading modifier is 0 or null irrespective of the distance. However, when a pressure amount is received from drawing input, the brush deformation system can increase the bristle spreading modifier as the distance from the brush base 402 increases.

For example, FIG. 4A shows the brush deformation system creating a deformed digital brush 400′ based on applying a deformed digital cage and the pressure amount 420. To illustrate, FIG. 4A shows a first cross-section 410a corresponding to the second bristle vertex 414b. The first cross-section 410a includes a first distance from the center axis 412 to the second bristle vertex 414b based on applying the deformed digital cage (e.g., without applying a bristle spreading modifier).

FIG. 4B shows the brush deformation system upon applying bristle spreading modifiers to both the first bristle vertex 414a and the second bristle vertex 414b. In particular, FIG. 4B shows a spread digital brush 400″ having spread bristles 406″. As shown, brush deformation system moves the first bristle vertex 414a and the second bristle vertex 414b further away from the center axis 412. Additionally, FIG. 4B includes a second cross-section 410b corresponding to the second bristle vertex 414b. The second cross-section 410b includes a second horizontal distance 418″ between the second bristle vertex 414b and the center axis 412 based on applying a bristle spreading modifier.

As a detailed example, to spread the second bristle vertex 414b, the brush deformation system applies the bristle spreading modifier to the first horizontal distance 418′. For example, the brush deformation system determines the bristle spreading modifier based on the pressure amount 420 and the vertical location of the second bristle vertex 414b (e.g., pressure amount×[1+vertical distance from the base]). The brush deformation system then applies (e.g., multiplies) the first horizontal distance 418′ to the bristle spreading modifier to obtain the second horizontal distance 418″ shown in the second cross-section 410b.

Upon determining the second horizontal distance 418″ the bristle spreading modifier moves the second bristle vertex 414b to a new location based on the second horizontal distance 418″. In particular, the brush deformation system moves the second bristle vertex 414b by determining a direction from the center axis 412 to the second bristle vertex 414b. The brush deformation system then moves the second bristle vertex 414b to the second horizontal distance 418″ in the determined direction. Thus, as shown in the second cross-section 410b of FIG. 4B, the brush deformation system moves the second bristle vertex 414b further from the center axis 412 (i.e., the second distance) as a result of applying the bristle spreading modifier.

In various embodiments, the brush deformation system moves a bristle vertex outside of a digital cage. As explained above, a digital cage, including a deformed digital cage, encompasses the bristles and bristle vertices. However, based on the bristle spreading modifier, the brush deformation system may position a bristle vertex beyond the constraints of the digital cage. For example, based on the determined second horizontal distance 418″, the brush deformation system moves the second bristle vertex 414b to a new spatial location that is outside the constraints of a deformed digital cage to provide further bristle tip splitting to the deformed digital brush 400′.

In one or more embodiments, the brush deformation system determines the bristle spreading modifier based on additional factors besides vertical distance and pressure amount. For example, in some embodiments, the brush deformation system adjusts the bristle spreading modifier based on user-specified spreading factors. Examples of user-specified spreading factors include bristle characteristics or a spreading tolerance.

To illustrate, FIG. 4C shows digital brushes 440a-d having various bristle characteristics. In one or more embodiments, bristle characteristics can include bristle stiffness, bristle thickness, or bristle shape. For example, as with real paintbrushes, digital brushes with stiffer bristles can reduce the bristle spreading modifier.

In some embodiments, bristle characteristics can include brush shape. For example, brushes having narrower shapes can reduce the bristle spreading modifier and brushes having wider shapes can increase the bristle spreading modifier. To illustrate, the first digital brush 440a will have a smaller bristle spreading modifier than the second digital brush 440b for a corresponding bristle vertex given the same vertical distance and pressure amount based on the different brush shapes.

In various embodiments, bristle characteristics can include bristle density. For instance, denser digital brushes with more bristles can reduce a bristle spreading modifier. To illustrate, the third digital brush 440c has a higher bristle density than the fourth digital brush 440d and, thus (all other things being equal), will have a smaller bristle spreading modifier than the fourth digital brush 440d.

In one or more embodiments, the brush deformation system receives user input indicating a spreading tolerance. For example, the brush deformation system can provide a user interface element (such as a slider or a numeric scale) that allows the user to specify a spreading tolerance (e.g., a number indicating additional bristle spreading or less bristle spreading). Based on the user-specified spreading tolerance, the brush deformation system can adjust the bristle spreading modifier accordingly.

In some embodiments, the brush deformation system can determine whether or not to apply additional bristle spread. For example, the brush deformation system can make this determination based on an amount of pressure, a location of the bristles, or user input (e.g., user selection of an option not to apply a bristle spreading modifier). For instance, if the pressure amount is above a pressure threshold, or if a bristle vertex is within a threshold buffer of an edge of the digital cage, the brush deformation system can determine to further spread the bristle vertex. Further, as mentioned above, the brush deformation system can apply a bristle spreading modifier independent of deformations resulting from a digital cage (e.g., before deformations determined from a digital cage, after deformations determined from a digital cage, or without deformations determined from a digital cage).

Upon deforming and/or spreading bristles of a digital brush, the brush deformation system can render a digital stroke. In particular, based on the position of bristle vertices, the brush deformation system can determine bristle vertices in contact with a digital canvas (i.e., contact bristle vertices). Moreover, the brush deformation system can collect the contact bristle vertices and determine a bristle implement (e.g., all of the bristles coming into contact with the canvas). Based on the bristle imprint, the brush deformation system can then transfer color (e.g., paint) from the bristle imprint to the digital canvas.

The brush deformation system can utilize a variety of approaches to model transfer of colors (e.g., paint) among bristle vertices and/or between bristle vertices and a digital canvas. For example, in one or more embodiments, the brush deformation system utilizes the approach described by Zhili Chen, Byungmoon Kim, Daichi Ito, and Huamin Wang in Wetbrush: GPU-based 3D Painting Simulation at the Bristle Level, ACM Transactions on Graphics, Proceedings of ACM SIGGRAPH Asia, vol. 34, Issue 6 (2015). However, the brush deformation system can enhance this approach by utilizing a digital cage, bristle spreading modifier, and/or other features described herein.

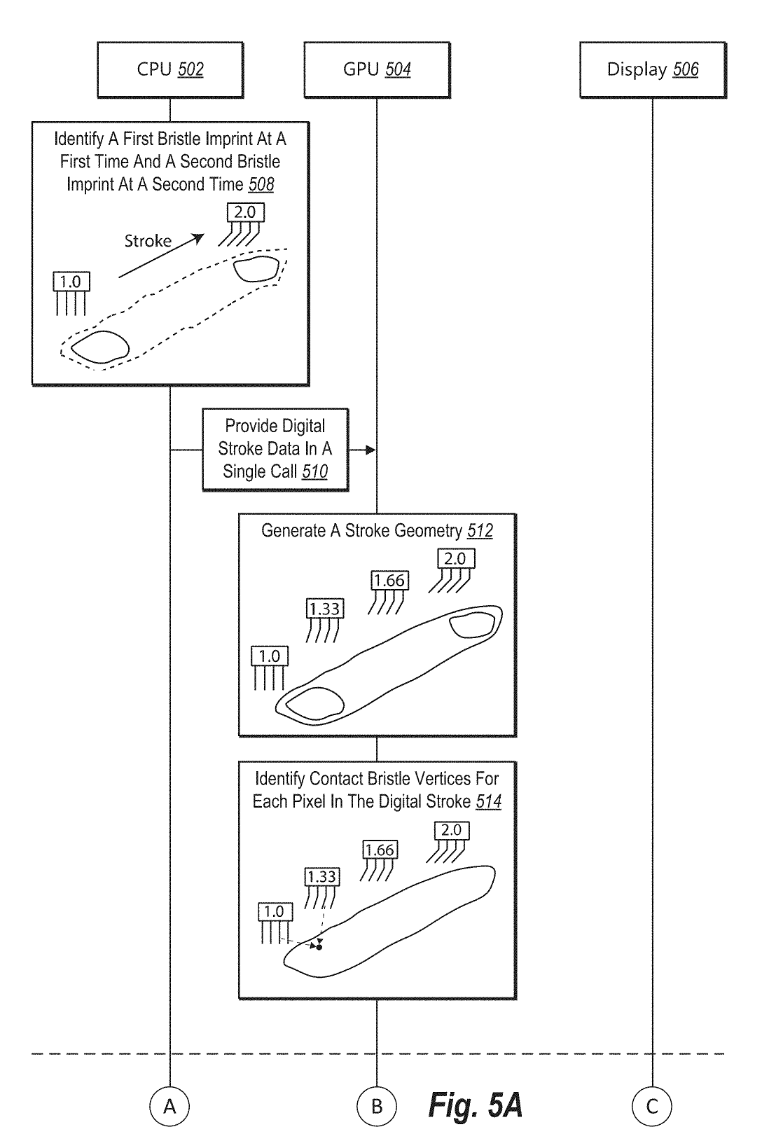

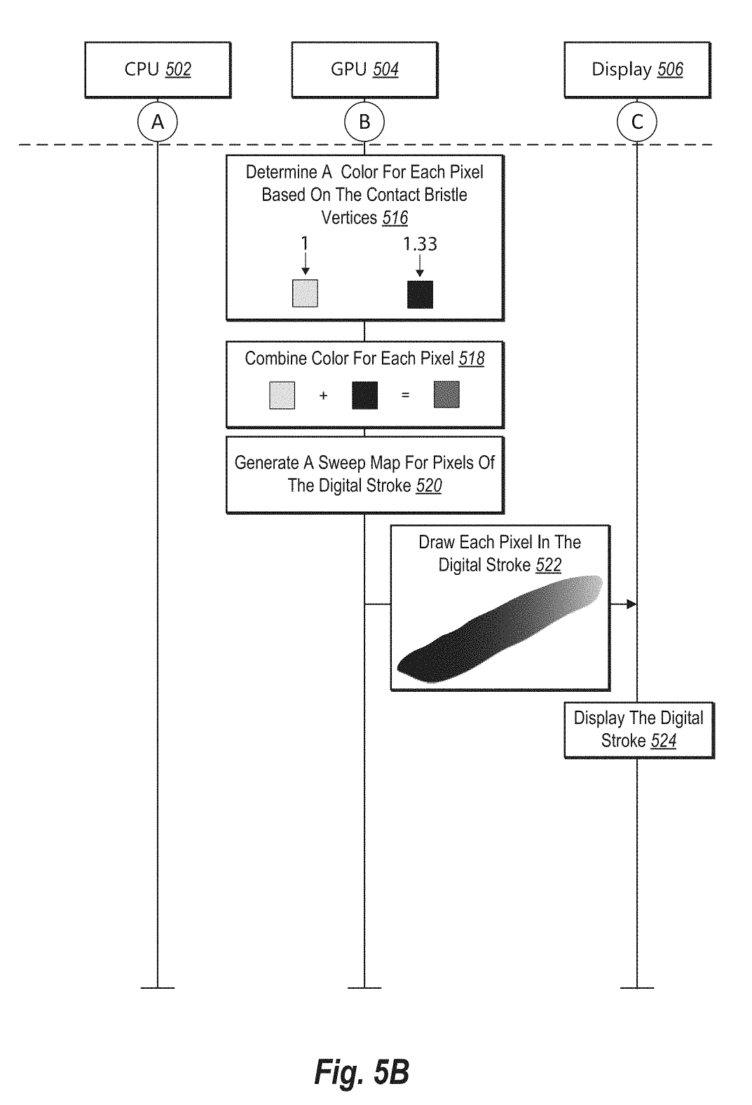

As mentioned above, the brush deformation system can also efficiently render individual digital paint strokes in one GPU shader pass. For instance, the brush deformation system can utilize a computer processing unit (CPU) to identify imprints of a digital brush and provides this data, along with color and texture information, to the GPU in a single drawing call. Specifically, the brush deformation system can identify a first bristle imprint at a first point in time (e.g., beginning of a digital stroke), identify a second bristle imprint at a second point in time, and utilize the first bristle imprint and the second bristle imprint to render the digital stroke utilizing a single GPU rendering pass. For example, FIGS. 5A and 5B illustrate utilizing a GPU of a computing device to generate a digital stroke in accordance with one or more embodiments.

To illustrate, FIGS. 5A and 5B illustrate the brush deformation system utilizing a CPU 502, a GPU 504 and a display 506 to perform a series of acts 508-524. In particular, the brush deformation system provides instructions to the CPU 502 and the GPU 504 (e.g., directly or via the CPU 502) to implement the acts 508-524.

As shown in FIG. 5A, the brush deformation system utilizes the CPU 502 to perform the act 508 of identifying a first bristle imprint at a first time and a second bristle imprint at a second time on a digital canvas. Specifically, the CPU 502 identifies drawing input from a drawing device that corresponds to a digital stroke. As described above, from the drawing input, the brush deformation system determines a first bristle deformation of the digital brush (e.g., modified locations of bristle vertices) at a first period of time (e.g., at time 1.0) at a first location on the digital canvas. Based on the first bristle deformation, the CPU 502 identifies a first bristle imprint. For instance, the CPU 502 identifies which bristle vertices contact the digital canvas at the first period of time. As described above, a deformed digital brush can have a number of bristle vertices on the same bristle or different bristles that contact the digital canvas.

In addition, the brush deformation system can determine a second bristle deformation at the second period of time (e.g., 2.0) at a second location on the digital canvas. For example, the brush deformation system can determine the first bristle deformation at the beginning of a digital stroke and determine the second bristle deformation at the end of a digital stroke. Based on the second bristle deformation, the CPU 502 identifies the second bristle imprint. In many embodiments, the first bristle imprint and the second bristle imprint will differ based on the changes applied to a drawing device between the first period of time and the second period of time (e.g., changes in position and/or pressure that cause bristles of the digital brush to deform).

To illustrate, the act 508 of FIG. 5A shows different bristle deformations between the first period of time and the second period of time. Further, the act 508 illustrates the outline of a digital stroke that is based on a first bristle imprint at the first period of time and the second bristle imprint at the second period of time.

As mentioned above, the brush deformation system can capture and/or render digital strokes in a variety of ways. For example, the brush deformation system can define a digital stroke based on drawing input (e.g., when a user initiates pressure on a drawing device or ceases pressure on a drawing device), based on a distance drawn on a digital canvas (e.g., every 10 pixels traversed), and/or based on a pre-determined time interval. In particular, in one or more embodiments, digital strokes are set at pre-determined time intervals such that a digital stroke is rendered based on drawing input received during one of the pre-determined time intervals. For instance, in relation to the act 508, the first bristle imprint and the second bristle imprint can correspond to drawing input received from a drawing device over a single one-second time interval. In some embodiments, the length of the time intervals can vary based on a number of factors, such as selected brush type, size, or width; canvas size; zoom level; or user-specified preferences. In some embodiments, time intervals are in the order of milliseconds (or less).

As shown, the brush deformation system also utilizes the CPU 502 to perform the act 510 of providing digital stroke data in a single call to the GPU 504. In particular, the CPU 502 provides the first bristle imprint (e.g., at the first point in time/location) and the second bristle imprint (at the second point in time/location) to the GPU 504 in a single drawing call. In some embodiments, the CPU 502 also provides color and texture information to the GPU 504 as part of the call.

In response, the brush deformation system utilizes the GPU 504 to perform the act 512 of generating a stroke geometry from the digital stroke. As shown, the stroke geometry is a reflection (e.g., outline) of the digital stroke without any coloring or pixel shading. In one or more embodiments, the GPU 504 employs a geometry shader to generate the stroke geometry of the digital stroke.

In various embodiments, to create stroke geometry, the GPU 504 interpolates bristle imprints between the first bristle deformation and the second bristle deformation to identify intermediary bristle deformations (e.g., bristle imprints at times 1.33 and 1.66). Based on the intermediary bristle deformations, the GPU 504 generates intermediary bristle imprints, which indicate the contours of the stroke between the first bristle imprint at the first location and the second bristle imprint at the second location of the digital canvas. In some embodiments, the number of intermediary bristle imprints generated by the GPU 504 is based on the length of the time interval and/or the distance between the first and second imprints.

As shown, the brush deformation system also utilizes the GPU 504 to perform the act 514 of identifying contact bristle vertices for each pixel on the digital canvas within the digital stroke (e.g., within the stroke geometry). In particular, the GPU 504 analyzes individual pixels in parallel within the stroke geometry to generate a sweep map in one single render pass within the single GPU draw call. More specifically, the GPU 504 uses the interpolation to identify, for each pixel in the digital stroke, what bristle vertices from bristle imprints contact the pixel on the digital canvas. In particular, the GPU 504 identifies when a bristle vertices from either the first bristle imprint, the second bristle imprint, or intermediary bristle imprints contact a pixel.

In one or more embodiments, the GPU 504 employs the pixel shader (i.e., fragment shader) to identify contact bristle vertices for each pixel. In addition, as mentioned above, the GPU 504 can also determine contact bristle vertices for multiple pixels in parallel. Because GPUs more efficiently process large parallel tasks (rather than smaller sequential processing tasks), this approach of analyzing pixels and contact bristle vertices for each pixel more efficiently utilizes the resources of the GPU 504 and reduces the computational time. In some embodiments, rather than employing the interpolation used to identify the stoke geometry (at the act 512), the GPU 504 (e.g., pixel shader) can generate a new interpolation (at the act 514) that interpolates bristle contact and color values for pixels in the digital stroke.

Indeed, as shown in the act 514 of FIG. 5A, the first bristle deformation (e.g., at the time 1.0) and the first intermediary bristle deformation (e.g., at the time 1.33) have at least one bristle vertex that contacts the illustrated pixel. Accordingly, the GPU 504 identifies the contact bristle vertices of the corresponding bristle imprints for the illustrated pixel. Because the second intermediary bristle deformation (e.g., at the time 1.66) and the second bristle deformation (e.g., 2.0) do not contact the illustrated pixel, the GPU 504 disregards bristle vertices from these bristle imprints.

Upon identifying contact bristle vertices for each pixel, the brush deformation system can also determine a resulting color for each pixel based on the contact bristle vertices. Indeed, as shown in FIG. 5B, the brush deformation system also utilizes the GPU 504 to perform the act 516 of determining a color for each pixel based on the bristle contact vertices. In particular, the GPU 504 determines a color value (e.g., an RGB value) for each pixel in the digital stroke based on the identified contact bristle vertices. As mentioned above, each bristle vertex can include one or more color values (e.g., paint stored and/or transported by the bristle vertex). Thus, when a bristle vertex contacts a pixel, the bristle vertex transfers the color to the pixel. Moreover, when multiple pixels contact a pixel (and each pixel has varying colors), the GPU 504 can determine a color (or combination of colors) to assign to the pixel.

To illustrate, the act 516 shows a light color from a bristle vertex of the first imprint (e.g., at the time 1.0) transferring to the illustrated pixel. Moreover, the act 516 shows a dark color from a bristle vertex of the first intermediary imprint (e.g., at the time 1.33) also transferring to the illustrated pixel. As shown in FIG. 5B, the GPU 504 combines the color for each pixel.

The GPU 504 can combine the colors from contact bristle vertices in a variety of ways. For example, in one or more embodiments, the GPU 504 averages the two colors. In some embodiments, the GPU 504 allocates a greater weight (e.g., a weighted average) to pixels that transfer color to a pixel at a later time. For example, the last color to transfer to a pixel has the greatest weight. In alternative embodiments, the GPU 504 identifies a new color by mixing the transferred colors.

Upon identifying colors for each pixel, the brush deformation system can then generate a digital stroke. For instance, as shown in FIG. 5B, the brush deformation system can utilize the GPU 504 to perform the act 520 of generating a sweep map for pixels of the digital stroke. In one or more embodiments, the sweep map indicates the identified color for each pixel in the digital stroke. Further, the GPU 504 can generate the sweep map for multiple pixels in parallel using the pixel shader. In this manner, the brush deformation system can leverage the architecture of the GPU 504 to efficiently and quickly generate a sweep map on the GPU 504.

To illustrate, the GPU 504 draws 522 each pixel in the digital stroke. In particular, the GPU 504 uses the sweep map to quickly color in each pixel of the digital stroke to the identified value. By employing the sweep map, the GPU 504 can reduce the overall rendering time of the digital stroke. Upon drawing the pixels in the digital stroke, the GPU 504 can provide the digital stoke to the display 506, which displays the digital stroke (at the act 524).

The acts described in relation to FIGS. 5A and 5B is intended to be illustrative of one or more series of acts in accordance with the present disclosure, and is not intended to limit potential embodiments. Alternative embodiments can include additional, fewer, or different acts than those articulated in FIGS. 5A and 5B. For instance, the act 520 and/or 522 may be encompassed within the acts 512-516. Moreover, in one or more embodiments, the GPU 504 may provide the digital stroke to the CPU 502 (and the CPU 502 then provides the stroke to the display 506).

Additionally, the acts described herein may be performed in a different order, may be repeated or performed in parallel with one another, or may be performed in parallel with different instances of the same or similar acts. Indeed, although FIGS. 5A and 5B include illustrations for a single illustrative pixel, as mentioned, the brush deformation system can perform similar acts in parallel for all pixels in a digital stroke. Further, the brush deformation system can repeat the acts illustrated in FIGS. 5A and 5B for multiple digital strokes in a digital painting.

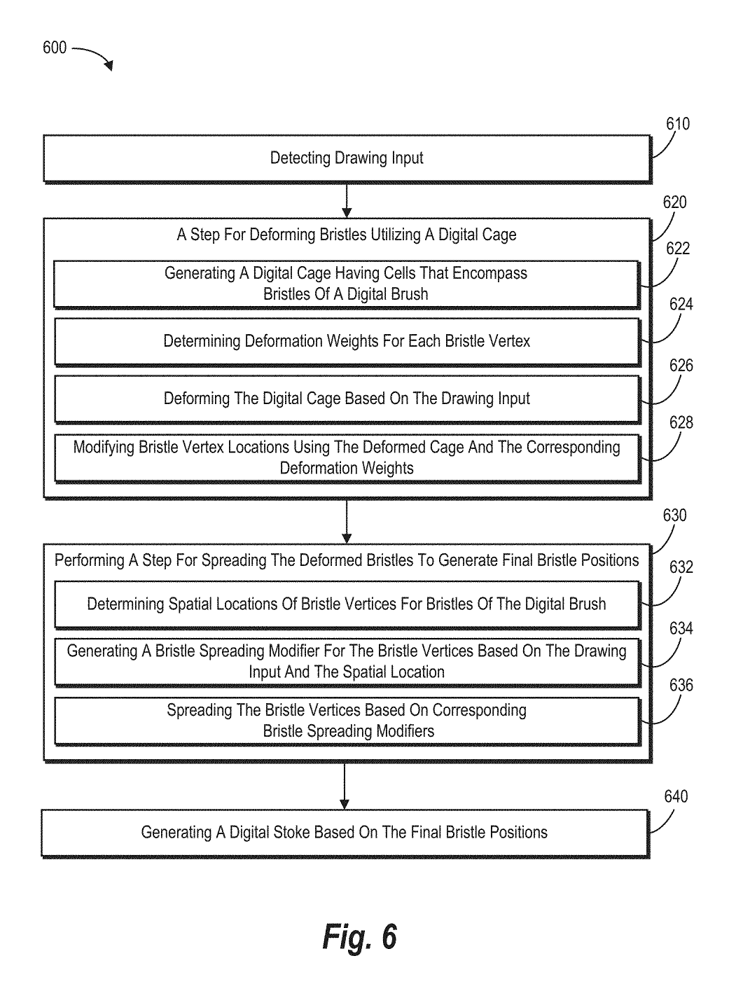

Turning now to FIG. 6, additional detail will be provided regarding a process for generating digital strokes in accordance with one or more embodiments. In particular, FIG. 6 illustrates a process 600 including acts in a step 620 for deforming bristles of a dynamic digital brush utilizing a digital cage as well as acts in a step 630 for spreading the deformed bristles based on a pressure amount in accordance with one or more embodiments. In one or more embodiments, the brush deformation system performs the process 600. For example, the brush deformation system performs the process 600 on a client device associated with a user.

As shown, FIG. 6 includes the act 610 of detecting drawing input. For example, in one or more embodiments, a user desiring to create a digital painting employs a content design application (and drawing device) that is associated with the brush deformation system. In addition, the user can select a digital brush and one or more colors. Upon the brush deformation system associating the selected digital brush with the selected color (e.g., “putting paint on the paintbrush”), the user provides drawing input that causes the digital brush to interact (e.g., draw on) the digital canvas. For example, the brush deformation system can utilize a pressure sensitive stylus and/or pressure sensitive drawing surface to receive drawing input (e.g., changes in position and/or pressure amount) that indicate corresponding changes to a digital brush to draw on a digital canvas.

As shown, FIG. 6 the process 600 also includes a step 620 for deforming bristles utilizing a digital cage. The step 620 for deforming bristles utilizing a digital cage can include the acts 622-628 shown in FIG. 6. As mentioned above, in various embodiments, a computing device, such as a client device, can perform the acts 622-628 included in the step 620.

As shown, the step 620 includes the act 622 of generating a digital cage having cells that encompass bristles (and bristle vertices) of a digital brush. For example, generating the digital cage can include generating cells that collectively surround bristles (and corresponding bristle vertices) of a digital brush. As mentioned previously, the digital cage can be any shape or configuration of cells. Additional description regarding generating a digital cage is provided above in connection with FIGS. 2B and 3A.

In addition, the step 620 also includes the act 624 of determining deformation weights for each bristle vertex (e.g., bristle vertices of the bristles of the digital brush). In one or more embodiments, determining deformation weights (i.e., skinning weights) includes determining distances between each bristle vertex and the cell in which the bristle vertex is located. For instance, the brush deformation system can compare the spatial location of a bristle vertex within a cell to determine one or more skinning weights for the bristle vertex. Additional description regarding determining deformation weights is provided above in connection with FIGS. 2B and 3B as well as Equations 1 and 2.

The step 620 also includes the act 626 of deforming the digital cage based on the drawing input. As mentioned above, drawing input can include the orientation or position of a drawing device and an applied pressure amount. Based on the drawing input, in various embodiments, the brush deformation system can deform cells in the digital cage. Together, each of the deformed cells makes up the deformed digital cage. Additional description regarding deforming the digital cage is provided above with respect to FIGS. 2C and 3B.

Further, the step 620 also includes the act 628 of modifying bristle vertex locations using the deformed cage and corresponding deformation weights. For example, in one or more embodiments, the brush deformation system applies the deformation weights determined for each bristle vertex to the deformed cell in which the bristle vertex is located to determine a new spatial location for the bristle vertex. Modifying bristle vertices, in turn, modifies the layout of the bristle to which a bristle vertex belongs. Thus, modifying bristle vertices to new spatial locations enables the brush deformation system to modify each bristle to conform to the overall deformation of the digital cage. Additional description regarding modifying bristle vertex locations is provided above in connection with FIGS. 2C, 2D, and 3B as well as Equation 3.

As shown, FIG. 6 also includes a step 630 for spreading the deformed bristles to generate final bristle locations. The step 630 can include the acts 632-636 shown in FIG. 6. As mentioned above, in various embodiments, a computing device, such as a client device, can perform the acts 632-638 included in the step 630.

As shown, the step 630 includes the act 632 of determining spatial locations of bristle vertices for bristles of the digital brush. For instance, in various embodiments, the brush deformation system identifies a vertical location and horizontal location of each bristle vertex. The vertical location can be with respect to the brush base or the brush tip (e.g., inversely applying the vertical distance described above with respect to the brush base). In addition, the vertical distance can include a distance along the bristle. Further, the horizontal location can be with respect to a center axis, as described above, or any other cross-sectional/longitudinal axis that extends from the brush base toward the brush tip. Additional description regarding determining spatial locations of bristle vertices is provided above with respect to FIGS. 2B, 3A, 4A, and 4B.

In addition, the step 630 includes the act of generating 634 a bristle spreading modifier for the bristle vertices based on the drawing input and the spatial location. For example, in some embodiments, the brush deformation system generates a bristle spreading modifier (e.g., bristle spreading multiplier) for a bristle vertex based on the vertical distance of the bristle vertex and the pressure amount applied to the digital brush, as indicated by the drawing input. For instance, a first bristle vertex that has a greater vertical distance (from the base) will result in a larger bristle spreading multiplier than a second bristle vertex with a smaller vertical distance (from the base). Further, in one or more embodiments, additional inputs, such as bristle characteristics and a user-specified spreading factor can further increase or decrease a bristle spreading multiplier. Additional description regarding generating bristle spreading modifier is provided above with respect to FIGS. 4A-4C.

The step 630 also includes the act 636 of spreading the bristle vertices based on corresponding bristle spreading modifiers. For example, in one or more embodiments, based on the bristle spreading modifier determined for a bristle vertex, the brush deformation system increases the horizontal distance of the bristle vertex to move away from the central axis (or another cross-section/longitudinal axis) to determine a new horizontal location of the bristle vertex.

As mentioned previously, spreading bristle vertices will in turn spread the bristles on which the bristle vertex is located. In general, given the same pressure amount, the brush deformation system will move a bristle vertex with a larger vertical distance (from the base) a farther horizontal distance than a bristle vertex with a smaller vertical distance (from the base). Thus, the tip of a bristle will spread further apart than the base of the bristle when pressure is applied. In this manner, the brush deformation system enables the digital brush to exhibit natural and controlled bristle tip splitting for various amounts of provided pressure. Additional description regarding bristle spreading is provided above with respect to FIGS. 4B and 4C.

As shown, FIG. 6 includes the act 640 of generating a digital stroke based on the deformed and spread bristles. For example, the brush deformation system draws a digital stroke using the deformed bristles and/or the spread bristles. As mentioned above, in one or more embodiments, the brush deformation system continues to deform and spread bristles of a digital brush during a digital stroke using the same actions described above based on ongoing drawing input. In some embodiments, the brush deformation system also employs a GPU to render the digital stroke using a single drawing call. Additional description regarding rendering a digital stroke is provided above with respect to FIGS. 5A and 5B.

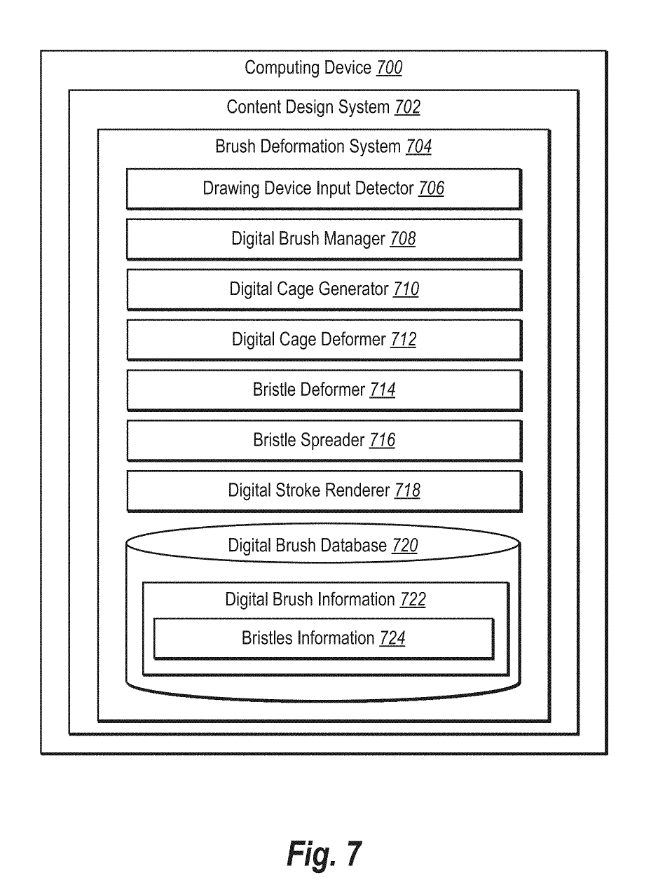

Turning now to FIG. 7, additional detail will be provided regarding capabilities and components of the brush deformation system 704 in accordance with one or more embodiments. In particular, FIG. 7 shows a schematic diagram of a computing device 700 that includes a content design system 702 and brush deformation system 704 (i.e., an exemplary implementation of the brush deformation system described above). In one or more embodiments, some or all of the components of the brush deformation system 704 can be implemented separately from the content design system 702. Moreover, the computing device 700 can include a variety of different devices. For example, in some embodiments, some or all of the components of the brush deformation system 704 are implemented on a client device and/or server device.

The content design system 702, in one or more embodiments, generally facilitates the creation, modification, sharing, and/or deletion of graphical content. Graphical content can include vector-based and/or raster-based content, such as digital paint strokes. In one or more embodiments, the content design system 702 is a design application such as ADOBE® ILLUSTRATOR®. In other embodiments, the content design system 702 includes multiple applications, functions, and operations relating to graphical content, such as an application suite, a web-based application and/or system operations on the computing device 700.

As shown, the brush deformation system 704 in FIG. 7 includes a drawing device input detector 706, a digital brush manager 708, a digital cage generator 710, a digital cage deformer 712, a bristle deformer 714, a bristle spreader 716, and a digital stroke renderer 718. In addition, the brush deformation system 704 includes a digital brush database 720 having digital brush information 722. The digital brush information 722 can include corresponding bristle information 724.

The drawing device input detector 706 can detect and receive various types of drawing input from a drawing device. For example, in one or more embodiments, the drawing device input detector 706 provides input regarding the orientation, position, and/or angle of a drawing device. In addition, the drawing device input detector 706 provides a pressure amount applied to the drawing device. Further, as the drawing input changes, such as during a digital stroke, the drawing device input detector 706 receives updated drawing input. In additional embodiments, the drawing device input detector 706 can also provide user selections, such as a selected digital brush, one or more selected colors, user-specified spreading factors, or other selections made by a user. Additional description regarding drawing input and drawing devices is provided above.

As shown, the brush deformation system 704 also includes the digital brush manager 708. The digital brush manager 708 can store, create, modify, enhance, share, and/or delete digital brushes. In one or more embodiments, the digital brush manager 708 maintains digital brush information 722 in the digital brush database 720. For example, digital brush information 722 includes the style, family, and characteristics (e.g., length, width, and/or weight) of each digital brush. In addition, digital brush information 722 can include bristle information 724, such as the number, shape, pattern, material, density, thickness, and/or arrangement of bristles on a digital brush, or other bristle information provided above.

As illustrated in FIG. 7, the brush deformation system 704 also includes the digital cage generator 710. The digital cage generator 710 can create a digital cage that encompasses bristles of a digital brush. For example, the digital cage generator 710 can generate any number of cells that match the shaped of the bristles on a digital brush, and can join the cells together to form the digital cage. As mentioned previously, a digital cage includes any shape or form that encompasses the bristles. In some embodiments, the digital cage generator 710 uses predetermined buffers and spacing when determining the size of a digital cage with respect to corresponding bristles. Additional information regarding generating digital cages is provided above in connection with FIGS. 2B and 3A.

As shown in FIG. 7, the brush deformation system 704 also includes the digital cage deformer. The digital cage deformer 712 can modify, shape, deform, and/or manipulate the overall shape of a digital cage based on drawing input (e.g., based on how drawing input corresponds to interaction between a digital brush and a digital canvas). In some embodiments, the digital cage deformer 712 modifies individual cells within a digital cage using soft body-second order elements and/or quadratic deformations. Together, the deformed cells influence the overall shape of digital cage. In one or more embodiments, the digital cage deformer 712 deforms multiple cells at the same time, as described previously (e.g., individually or in groups). Further description regarding modifying and deforming the digital cage is provided above with respect to FIGS. 2C and 3B.

As illustrated in FIG. 7, the brush deformation system 704 also includes the bristle deformer 714. The bristle deformer 714 can reshape bristles of a digital brush based on drawing input. For example, in one or more embodiments, the bristle deformer 714 determines and employs one or more deformation weights to modify bristle vertices to new spatial locations within a deformed digital cage. By aligning bristle vertices with a deformed cage, the bristle deformer 714 realigns corresponding bristles to match the overall shape of a deformed digital cage in a computationally inexpensive manner. Indeed, the bristle deformer 714 can quickly modify hundreds or thousands of bristles in real-time to determine bristle deformations corresponding to drawing input. Additional description regarding deforming bristles as provided above in connection with FIGS. 2C-2D and 3B.

The bristle spreader 716 can also provide increased tip-splitting bristle control to a user. For example, in some embodiments, the bristle spreader 716 employs a bristle spreading modifier (e.g., multiplier) to bristles away from a center axis when pressure is applied to a digital brush. In one or more embodiments, the bristle spreading modifier is a function of distance, a pressure amount, and/or other factors, such as bristle characteristics and or user-specified spreading factors. In various embodiments, the bristle spreader 716 limits bristle spreading within a threshold distance of the tip of a bristle (e.g., bristle vertices within the last 10% of the bristle or three or less bristle vertices). In some embodiments, the bristle spreader 716 determines which bristle vertices on a bristle to apply a bristle spreading modifier based on the applied pressure amount (e.g., the larger the pressure, the more bristle vertices affected).

In one or more embodiments, the bristle spreader 716 further splits or spreads bristles that have been deformed using a digital cage. In alternative embodiments, the bristle spreader 716 can provide bristle spreading to bristles of a digital brush independent of a digital cage. Additional description regarding bristle spreading modifiers with respect to FIGS. 4A-4C.

As shown in FIG. 7, the brush deformation system 704 also includes the digital stroke renderer 718. The digital stroke renderer 718 can draw, render, paint, display, and/or show a digital stroke. For example, the digital stroke renderer 718 can receive digital stroke data that indicates the shape or configuration of deformed bristles on a digital brush and determine an imprint. In some embodiments, the digital stroke renderer 718 determines contact between bristle vertices of the digital brush and a digital campus with respect to the imprint. For example, digital stroke renderer 718 transfers one or more colors from contact bristle vertices to affected pixels within the digital stroke. Further description regarding rendering digital strokes is provided above in connection with FIGS. 5A and 5B.

In one or more embodiments, the GPU of the computing device implements the digital stroke renderer 718. For example, the CPU sends a single drawing call to the GPU with stroke data, and the GPU determines, in parallel, a sweep map for the digital stroke based on interpolating two bristle imprints. Further, the GPU can efficiently employ portions of the GPU, such as a geometry shader and pixel shader (i.e., fragment shader) to render a digital stroke. Additional description regarding the GPU rendering the digital stroke is provided above in connection with FIGS. 5A and 5B.

The components 706-724 of the brush deformation system 704 can include software, hardware, or both. For example, the components 706-724 can include one or more instructions stored on a computer-readable storage medium and executable by processors of one or more computing devices, such as a client device or server device. When executed by the one or more processors, the computer-executable instructions of the brush deformation system 704 can cause the computing device(s) to perform the feature learning methods described herein. Alternatively, the components 706-724 can include hardware, such as a special-purpose processing device to perform a certain function or group of functions. Alternatively, the components 706-724 of the brush deformation system 704 can include a combination of computer-executable instructions and hardware.

Furthermore, the components 706-724 of the brush deformation system 704 can, for example, be implemented as one or more operating systems, as one or more stand-alone applications, as one or more modules of an application, as one or more plug-ins, as one or more library functions or functions that can be called by other applications, and/or as a cloud-computing model. Thus, the components 706-724 can be implemented as a stand-alone application, such as a desktop or mobile application. Furthermore, the components 706-724 can be implemented as one or more web-based applications hosted on a remote server. The components 706-724 can also be implemented in a suite of mobile device applications or “apps.” To illustrate, the components 706-724 can be implemented in an application, including but not limited to ADOBE® ILLUSTRATOR®, ADOBE PHOTOSHOP®, ADOBE® CREATIVE CLOUD® software. “ADOBE,” “ILLUSTRATOR,” “PHOTOSHOP,” and “CREATIVE CLOUD” are either registered trademarks or trademarks of Adobe Systems Incorporated in the United States and/or other countries.

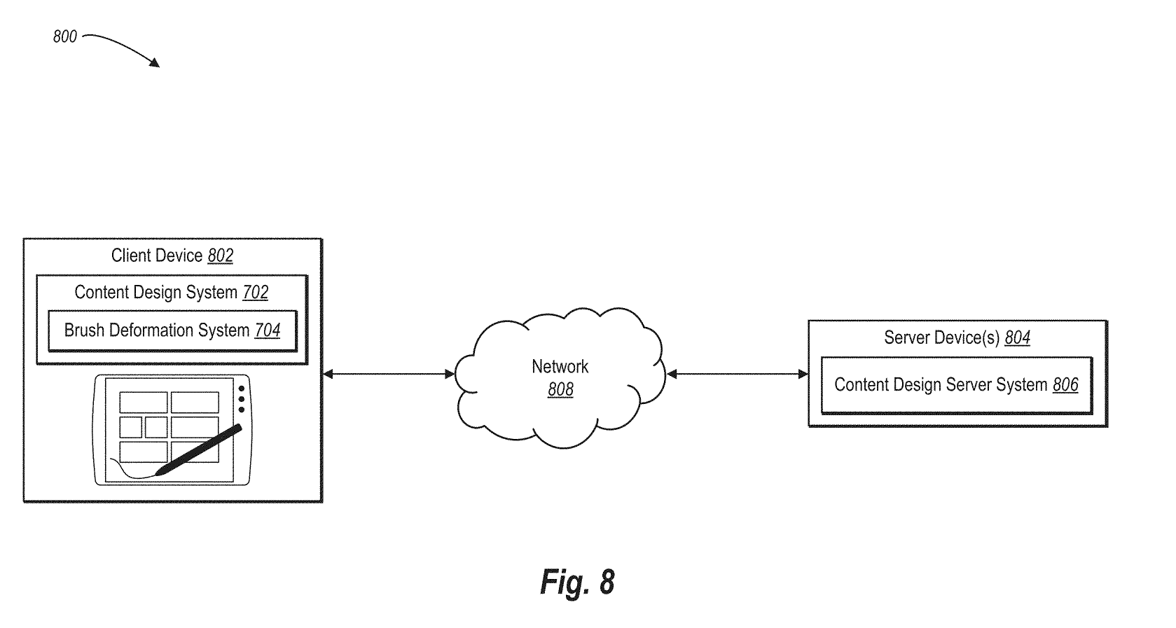

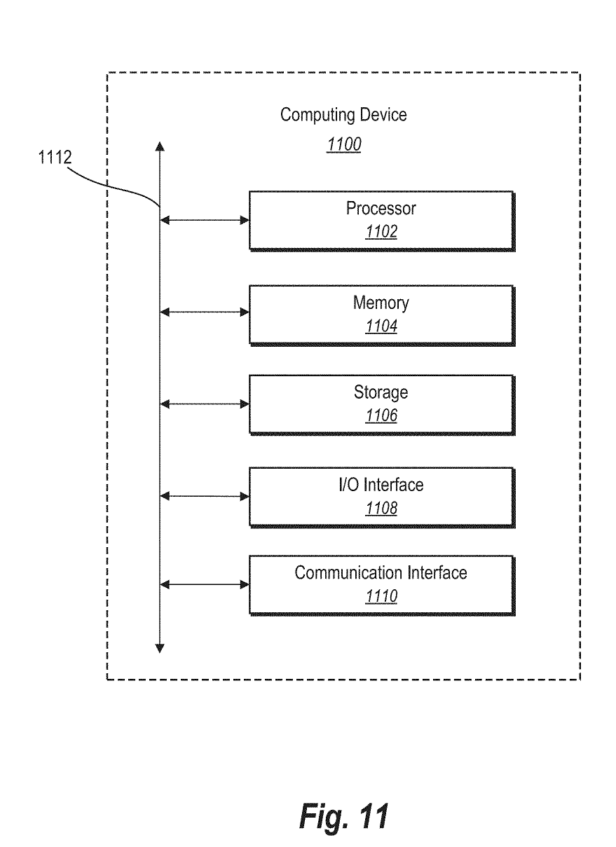

FIG. 8 illustrates a schematic diagram of an environment 800 in which the brush deformation system 704 may be implemented in accordance with one or more embodiments. In one or more embodiments, the environment 800 includes various computing devices including a client device 802 and server device(s) 804. In addition, the environment 800 includes a network 808. The network 808 may be any suitable network over which the computing devices can communicate. Example networks are discussed in more detail below with regard to FIG. 11.

As illustrated in FIG. 8, the environment 800 includes the client device 802. The client device 802 may comprise any computing device, such as the computing device described below in relation to FIG. 11. As shown, the client device includes the content design system 702 and the brush deformation system 704, which are described previously. For example, as described above, the brush deformation system 704 dynamically deforms bristles of a digital brush using a digital cage and/or spreads bristle tips based on drawing input. Further, the brush deformation system 704 accurately, intuitively, and realistically models digital brushes in a computationally inexpensive manner. In addition, as illustrated, the client device 802 can include a drawing device (e.g., a stylus or a touchscreen) that provides drawing input, as explained earlier.

In addition, the environment 800 includes the server device(s) 804, which may comprise any computing device, such as one or more of the computing devices described below in relation to FIG. 11. The server device(s) 804 can generate, store, receive, and transmit any type of data, including graphical content (e.g., digital strokes) and/or digital brushes. As shown, the server device(s) 804 includes a content design server system 806 that communicates with the content design system 702 on the client device 802. For example, the content design server system 806 transmits graphical content to the client device 802, which enables the client device 802 to render digital strokes using deformable and spreadable digital brushes. Notably, while only a single server device is shown, the content design server system 806 can be implemented across multiple server devices.

While not illustrated, in one or more embodiments, the server device(s) 804 can also include all, or a portion of, the brush deformation system 704, such as within the content design server system 806. For example, when located in the server device(s) 804, the brush deformation system 704 can comprise an application running on the server device(s) 804 or a portion of a software application that can be downloaded to the client device 802. For instance, the brush deformation system 704 includes a web hosting application that allows the client device 802 to interact with content from the content design server system 806 hosted on the server device(s) 804. In this manner, the server device(s) 804 can perform digital brush deformation based on a digital cage, bristle tip spreading, and/or stroke rendering (or portions thereof) and enable the client device 802 to complete processing and/or rendering a digital stroke.

Although FIG. 8 illustrates a particular arrangement of the server device(s) 804, the client device 802 and the network 808, various additional arrangements are possible. For example, while FIG. 8 illustrates the one or more client device 802 communicating with the server device(s) 804 via the network 808, in one or more embodiments a single client device may communicate directly with the server device(s) 804, bypassing the network 808.

Similarly, although the environment 800 of FIG. 8 is depicted as having various components, the environment 800 may have additional or alternative components. For example, the brush deformation system 704 can be implemented on multiple computing devices. In particular, the brush deformation system 704 may be implemented in whole by the server device(s) 804 or the brush deformation system 704 may be implemented in whole by the client device 802. Alternatively, the brush deformation system 704 may be implemented across multiple devices or components (e.g., utilizing the server device(s) 804 and the one or more client device 802).

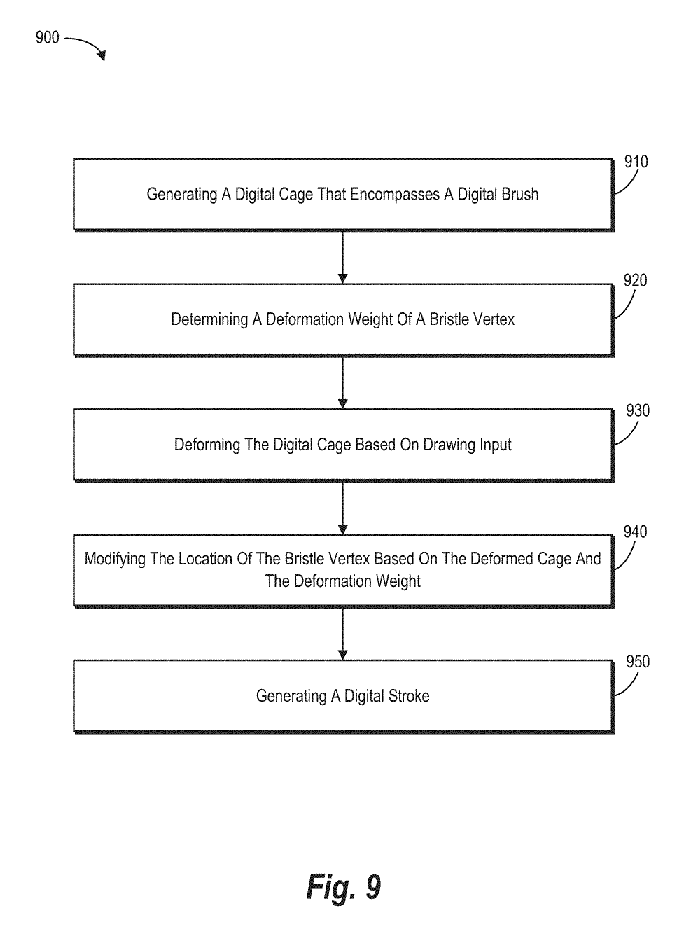

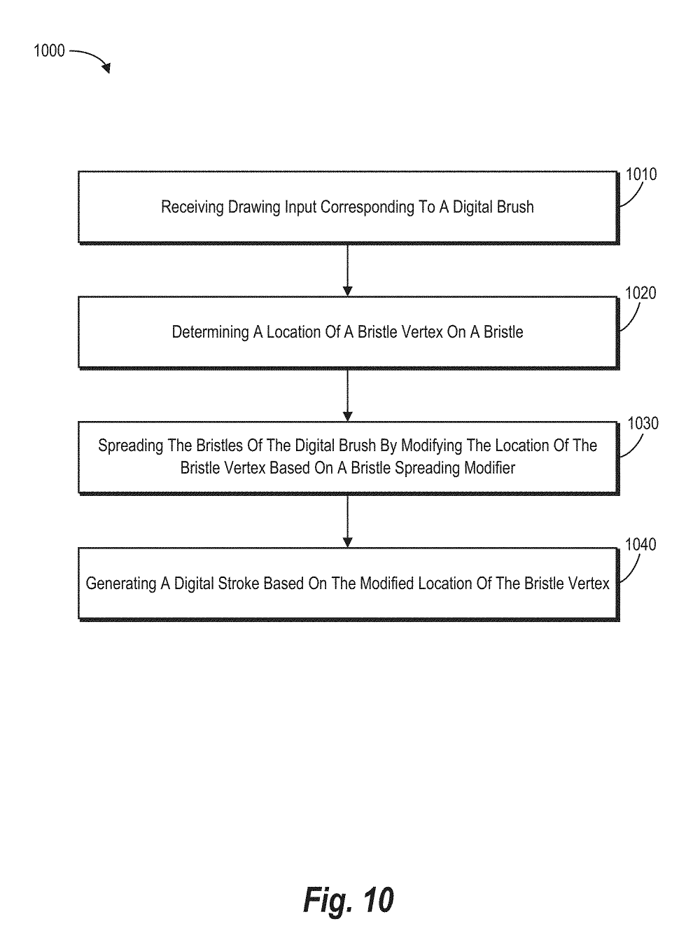

FIGS. 1-8, the corresponding text, and the examples provide a number of different systems, methods, techniques, components, and/or devices of the brush deformation system 704 in accordance with one or more embodiments. In addition to the above description, one or more embodiments can also be described in terms of flowcharts including acts for accomplishing a particular result. For example, FIGS. 9 and 10 illustrate flowcharts of an exemplary sequence of acts in accordance with one or more embodiments. FIGS. 9 and 10 may be performed with more or fewer acts. Further, the acts may be performed in differing orders. Additionally, the acts described herein may be repeated or performed in parallel with one another or parallel with different instances of the same or similar acts.

While FIGS. 9 and 10 illustrate series of acts according to particular embodiments, alternative embodiments may omit, add to, reorder, and/or modify any of the acts shown in FIGS. 9 and 10. The series of acts of FIGS. 9 and 10 can be performed as part of a method. Alternatively, a non-transitory computer-readable medium can comprise instructions, that when executed by one or more processors, cause a computing device to perform the series of acts of FIGS. 9 and 10. In still further embodiments, a system can perform the acts of FIGS. 9 and 10.

The series of acts 900 includes an act 910 of generating a digital cage that encompasses a digital brush. In particular, the act 910 can involve generating a digital cage that encompasses bristles of a digital brush. In addition, the digital cage can include a first cell that encompasses a subset of bristle vertices of the bristles. In some embodiments, the digital cage includes cells having cell vertices and each of the bristles of the digital brush passes through multiple cells of the digital cage from a digital brush base to a digital brush tip. In one or more embodiments, the first cell includes a first cell vertex.

As shown in FIG. 9, the series of acts 900 further includes an act 920 of determining a deformation weight of a bristle vertex. In particular, the act 920 can involve determining a deformation weight of a first bristle vertex of the subset of bristle vertices within the first cell based on a spatial location of the first bristle vertex within the first cell. In some embodiments, the act 920 includes determining a first distance between the first cell vertex and the first bristle vertex and/or determining the deformation weight of the first bristle vertex of the first cell based on the first distance and, in some cases, a deformation constant.

The series of acts 900 also includes an act 930 of deforming the digital cage based on drawing input. In particular, the act 930 can involve deforming the first cell in the digital cage based on drawing input received from a drawing device. In some embodiments, the drawing input received from the drawing device indicates a change in position of the digital brush relative to a digital canvas and/or a pressure amount from a pressure sensitive drawing device associated with the digital brush. In various embodiments, the first cell has a greater deformation for the pressure amount when the spatial location of the first cell within the digital cage is near the digital brush tip and a lesser deformation for the pressure amount when the spatial location of the first cell within the digital cage is near the digital brush base.

As shown, the series of acts 900 also includes an act 940 of modifying the location of the bristle vertex based on the deformed cage and the deformation weight. In particular, the act 940 can involve modifying the spatial location of the first bristle vertex within the first cell based on the deformed first cell and the deformation weight. In various embodiments, the act 940 includes modifying coordinates of the first cell vertex based on the change in position of the digital brush relative to the digital canvas and the pressure amount from the pressure sensitive device. In some embodiments, the act 940 includes modifying the spatial location of the first bristle vertex within the first cell based on the modified coordinates of the first cell vertex and the deformation weight.

As shown in FIG. 9, the series of acts 900 further includes an act 950 of generating a digital stroke. In particular, the act 950 can involve generating a digital stroke using the bristles based on the modified spatial location of the first bristle vertex within the first cell. In various embodiments, the act 950 includes determining that the modified spatial location of the first bristle vertex at a first point in time is in contact with a digital canvas, and identifying a first bristle imprint based on the modified spatial location of the first bristle vertex at the first point in time, and rendering a digital stroke based on the first bristle imprint.

In additional embodiments, the act 950 includes identifying a second bristle imprint based on a second modified spatial location of the first bristle vertex at a second point in time, and providing a single drawing call to a GPU that causes the GPU to render the digital stroke from the single drawing call based on the first bristle imprint at the first point in time and the second bristle imprint at the second point in time. Further, in some embodiments, the act 950 also includes identifying a plurality of contact bristle vertices for the pixel by interpolating between the first bristle imprint and the second bristle imprint, determining a plurality of color values corresponding to the plurality of contact bristle vertices for the pixel, and rendering the pixel based on the plurality of color values.

As mentioned above, FIG. 10 illustrates an example flow diagram of a series of acts 1000 for generating a digital paint stroke using a bristle spreading modifier. In particular, the series of acts 1000 illustrate generating realistic digital paint strokes in electronic documents where the digital paint strokes reflect individual bristles of digital brushes. In one or more embodiments, the series of acts 1000 is implemented on a computing device, such as the client device 802. Further, in some embodiments, the series of acts 1000 is implemented in a digital environment for simulating digital painting within electronic documents.

As shown, the series of acts 1000 includes an act 1010 of receiving drawing input corresponding to a digital brush. In particular, the act 1010 can involve receiving drawing input from a drawing device, the drawing input indicating a pressure amount and a change in position of the digital brush relative to a digital canvas. In one or more embodiments, the digital brush includes a base, a tip, and a cross-sectional axis. In additional embodiments, the cross-sectional axis is a center axis that extends from the center of the digital brush base.

The series of acts 1000 also includes an act 1020 of determining a location of a bristle vertex on a bristle. In particular, the act 1020 can involve determining a first vertical location and a first horizontal location of a bristle vertex on a bristle of the digital brush based on the drawing input. In some embodiments, the vertical location of the bristle vertex on the bristle is based on a vertical distance from at least one of the base of the digital brush (or the tip of the digital brush) and/or the horizontal location of the bristle vertex on the bristle is based on a horizontal distance from the cross-sectional axis of the digital brush.

In addition, the series of acts 1000 includes an act 1030 of spreading the bristles of the digital brush by modifying the location of the bristle vertex based on a bristle spreading modifier. In particular, the act 1030 can involve spreading the bristles of the digital brush based on the pressure amount by determining a bristle spreading modifier utilizing the pressure amount and the first vertical location of the bristle vertex and modifying the first horizontal location of the bristle vertex based on the bristle spreading modifier. In one or more embodiments, the bristle spreading modifier is a multiplier based on the pressure amount, the vertical location of the bristle vertex, and, in some cases, a user-specified spreading factor.

In various embodiments, the act 1030 also includes determining a direction from the cross-sectional axis of the digital brush to the first horizontal location of the bristle vertex, and modifying the first horizontal location of the bristle vertex by moving the bristle vertex in the direction from the cross-sectional axis of the digital brush to the first horizontal location of the bristle vertex based on the bristle spreading modifier. In some embodiments, the act 1030 includes identifying a second bristle vertex at a second vertical location on the bristle of the digital brush where the second vertical location is nearer to the tip of the digital brush than the first vertical location, and determining an additional bristle spreading modifier that is greater than the bristle spreading modifier based on the second vertical location being nearer the tip of the digital brush than the first vertical location

Further, the series of acts 1000 includes an act 1040 of generating a digital stroke based on the modified location of the bristle vertex. In particular, the act 1040 can involve generating a digital stroke based on the modified horizontal location of the bristle vertex on the bristle. In some embodiments, the act 1040 includes determining that the modified horizontal location of the first bristle vertex at a first point in time is in contact with a digital canvas, and identifying a first bristle imprint based on the modified horizontal location of the first bristle vertex at the first point in time, and rendering a digital stroke based on the first bristle imprint.

The series of acts 1000 can also include a number of additional acts. In one or more embodiments, the series of acts 1000 includes the act of generating a digital cage that encompasses the bristles of the digital brush where the digital cage includes cells having a first cell that encompasses the bristle vertex, deforming the digital cage and the first cell based on the drawing input, and determining the first vertical location and the first horizontal location based on the deformed first cell and a deformation weight.

The term “digital environment,” as used herein, generally refers to an environment implemented, for example, as a stand-alone application (e.g., a personal computer or mobile application running on a computing device), as an element of an application, as a plug-in for an application, as a library function or functions, as a computing device, and/or as a cloud-computing system. A digital medium environment allows the brush deformation system to deform and spread bristles of a digital brush, as described herein.

Embodiments of the present disclosure can include or utilize a special-purpose or general-purpose computer including computer hardware, such as, for example, one or more processors and system memory, as discussed in additional detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media accessible by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can include at least two distinctly different kinds of computer-readable media: non-transitory computer-readable storage media (devices) and transmission media.

Non-transitory computer-readable storage media (devices) includes RAM, ROM, EEPROM, CD-ROM, solid state drives, Flash memory, phase-change memory, other types of memory, other optical disk storage, magnetic disk storage or other magnetic storage devices, or any other medium used to store desired program code means in the form of computer-executable instructions or data structures, and accessible by a general-purpose or special-purpose computer.

Computer-executable instructions include, for example, instructions and data which, when executed by a processor, cause a general-purpose computer, special-purpose computer, or special-purpose processing device to perform a certain function or group of functions. In some embodiments, a general-purpose computer executes computer-executable instructions to turn the general-purpose computer into a special-purpose computer implementing elements of the disclosure. The computer executable instructions can be, for example, binaries, intermediate format instructions such as assembly language, or even source code. Although the subject matter has been described in language specific to structural features and/or methods, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an exemplary computing device 1100 that can be configured to perform one or more of the processes described above. One will appreciate that one or more computing devices, such as the computing device 1100 can represent the computing device 700, the client device 802, and/or the server device(s) 804 described above. In one or more embodiments, the computing device 1100 can be a mobile device (e.g., a mobile telephone, a smartphone, a PDA, a tablet, a laptop, a camera, a tracker, a watch, a wearable device, etc.). In some embodiments, the computing device 1100 can be a non-mobile device (e.g., a desktop computer or another type of client device). Further, the computing device 1100 can be a server device that includes cloud-based processing and storage capabilities.

As shown in FIG. 11, the computing device 1100 can include one or more processor(s) 1102, memory 1104, a storage device 1106, input/output (“I/O”) interfaces 1108, and a communication interface 1110, which can be communicatively coupled by way of a communication infrastructure (e.g., bus 1112). While the computing device 1100 is shown in FIG. 11, the components illustrated in FIG. 11 are not intended to be limiting. Additional or alternative components can be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 can retrieve (or fetch) the instructions from an internal register, an internal cache, memory 1104, or a storage device 1106 and decode and execute them.

The computing device 1100 includes memory 1104, which is coupled to the processor(s) 1102. The memory 1104 can be used for storing data, metadata, and programs for execution by the processor(s). The memory 1104 can include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 can be internal or distributed memory.

The computing device 1100 includes a storage device 1106 includes storage for storing data or instructions. As an example, and not by way of limitation, the storage device 1106 can include a non-transitory storage medium described above. The storage device 1106 can include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user digital strokes), receive output from, and otherwise transfer data to and from the computing device 1100. These I/O interfaces 1108 can include a mouse, keypad or a keyboard, a touch screen, camera, optical scanner, network interface, modem, other known I/O devices or a combination of such I/O interfaces 1108. The touch screen can be activated with a stylus or a finger.

The I/O interfaces 1108 can include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data can be representative of one or more graphical user interfaces and/or any other graphical content as can serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 can include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention can be embodied in other specific forms without departing from its spirit or essential characteristics. The described embodiments are to be considered in all respects only as illustrative and not restrictive. For example, the methods described herein can be performed with fewer or more steps/acts or the steps/acts can be performed in differing orders. Additionally, the steps/acts described herein can be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A non-transitory computer-readable medium for generating realistic digital paint strokes in electronic documents where the digital paint strokes reflect individual bristles of digital brushes, the non-transitory computer-readable medium storing instructions that, when executed by at least one processor, cause a computer system to:
generate a digital cage comprising a plurality of cells that encompasses bristles of a digital brush, the plurality of cells comprising a first cell that encompasses a subset of bristle vertices of the bristles;
determine a deformation weight of a first bristle vertex of the subset of bristle vertices within the first cell of the plurality of cells in the digital cage based on a spatial location of the first bristle vertex within the first cell;
deform the first cell of the plurality of cells in the digital cage based on drawing input received from a drawing device;
modify the spatial location of the first bristle vertex within the first cell of the plurality of cells in the digital cage based on the deformed first cell and the deformation weight; and
generate a digital stroke using the bristles based on the modified spatial location of the first bristle vertex within the first cell.

2. The non-transitory computer-readable medium of claim 1, wherein the digital cage comprises cells having cell vertices, and wherein each of the bristles of the digital brush passes through multiple cells of the digital cage from a digital brush base to a digital brush tip.

3. The non-transitory computer-readable medium of claim 2, wherein the first cell comprises a first cell vertex, and further comprising instructions that, when executed by the at least one processor, cause the system to determine the deformation weight of the first bristle vertex by:
determining a first distance between the first cell vertex and the first bristle vertex; and
determining the deformation weight of the first bristle vertex of the first cell based on the first distance.

4. The non-transitory computer-readable medium of claim 3, wherein the drawing input received from the drawing device indicates:
a change in position of the digital brush relative to a digital canvas; and
a pressure amount from a pressure sensitive drawing device associated with the digital brush.

5. The non-transitory computer-readable medium of claim 4, wherein the first cell has a greater deformation for the pressure amount when the spatial location of the first cell within the digital cage is near the digital brush tip and a lesser deformation for the pressure amount when the spatial location of the first cell within the digital cage is near the digital brush base.

6. The non-transitory computer-readable medium of claim 5, further comprising instructions, that when executed by the at least one processor, causes the computer system to deform the first cell by modifying coordinates of the first cell vertex based on the change in position of the digital brush relative to the digital canvas and the pressure amount from the pressure sensitive device.

7. The non-transitory computer-readable medium of claim 6, further comprising instructions, that when executed by the at least one processor, causes the computer system to modify the spatial location of the first bristle vertex within the first cell based on the modified coordinates of the first cell vertex and the deformation weight.

8. The non-transitory computer-readable medium of claim 1, wherein the instructions cause the computing system to generate the digital stroke using the bristles based on the modified spatial location of the first bristle vertex by:
determining that the modified spatial location of the first bristle vertex at a first point in time is in contact with a digital canvas;
identifying a first bristle imprint based on the modified spatial location of the first bristle vertex at the first point in time; and
rendering a digital stroke based on the first bristle imprint.

9. The non-transitory computer-readable medium of claim 8, further comprising instructions that, when executed by the at least one processor, cause the computing system to render the digital stroke based on the first bristle imprint by:
identifying a second bristle imprint based on a second modified spatial location of the first bristle vertex at a second point in time; and
providing a single drawing call to a graphical processing unit (GPU) that causes the GPU to render the digital stroke from the single drawing call based on the first bristle imprint at the first point in time and the second bristle imprint at the second point in time.

10. The non-transitory computer-readable medium of claim 9, further comprising instructions that, when executed by the at least one processor, cause the computer system to render the digital stroke from the single drawing call, for each pixel in the digital stroke by:
identifying a plurality of contact bristle vertices for the pixel by interpolating between the first bristle imprint and the second bristle imprint;
determining a plurality of color values corresponding to the plurality of contact bristle vertices for the pixel; and
rendering the pixel based on the plurality of color values.

11. A system for generating realistic digital paint strokes in electronic documents where the digital paint strokes reflect individual bristles of digital brushes, the system comprising:
a memory comprising a digital brush having bristles, each bristle having a plurality of bristle vertices;
at least one processor; and
at least one non-transitory computer-readable storage medium storing instructions that, when executed by the at least one processor, cause the system to:
receive drawing input from a drawing device, the drawing input indicating a pressure amount and a change in position of the digital brush relative to a digital canvas;
determine, based on the drawing input, a first vertical location and a first horizontal location of a bristle vertex on a bristle of the digital brush by:
generating a digital cage comprising a plurality of cells that encompasses the bristles of the digital brush, the plurality of cells comprising a first cell that encompasses the bristle vertex;
deforming the digital cage and the first cell based on the drawing input; and
determining the first vertical location and the first horizontal location based on the deformed first cell and a deformation weight;
spread the bristles of the digital brush based on the pressure amount by:
determining a bristle spreading modifier utilizing the pressure amount and the first vertical location of the bristle vertex; and
modifying the first horizontal location of the bristle vertex based on the bristle spreading modifier; and
generate a digital stroke based on the modified horizontal location of the bristle vertex on the bristle.

12. The system of claim 11, further comprising instructions that, when executed by the at least one processor, cause the system to determine the bristle spreading modifier by multiplying the pressure amount by a constant plus the first vertical location of the bristle vertex.

13. The system of claim 11, wherein:
the digital brush comprises a base, a tip, and a cross-sectional axis;
the vertical location of the bristle vertex on the bristle is based on a vertical distance from at least one of the base of the digital brush or the tip of the digital brush; and
the horizontal location of the bristle vertex on the bristle is based on a horizontal distance from the cross-sectional axis of the digital brush.

14. The system of claim 13, further comprising instructions that, when executed by the at least one processor, cause the system to:
determine a direction from the cross-sectional axis of the digital brush to the first horizontal location of the bristle vertex; and
modify the first horizontal location of the bristle vertex by moving the bristle vertex in the direction from the cross-sectional axis of the digital brush to the first horizontal location of the bristle vertex based on the bristle spreading modifier.

15. The system of claim 14, wherein the bristle spreading modifier is based on the pressure amount, the vertical location of the bristle vertex, and a user-specified spreading factor.

16. The system of claim 14, further comprising instructions that, when executed by the at least one processor, cause the system to:
identify a second bristle vertex at a second vertical location on the bristle of the digital brush, wherein the second vertical location is nearer to the tip of the digital brush than the first vertical location; and
determine, based on the second vertical location being nearer the tip of the digital brush than the first vertical location, an additional bristle spreading modifier that is greater than the bristle spreading modifier.

17. In a digital medium environment for simulating digital painting within electronic documents, a computer-implemented method of generating realistic digital paint strokes reflecting individual bristles of digital brushes, comprising:
detecting drawing input, including a pressure amount, from a pressure-sensitive device;
performing a step for deforming bristles of a digital brush utilizing a digital cage;
performing a step for spreading the deformed bristles based on the pressure amount to generate final bristle locations; and
generating a digital stroke based on the final bristle locations of the digital brush.

18. The method of claim 17, wherein generating the digital stroke based on the final bristle locations of the digital brush comprises:
determining that a modified spatial location of a first bristle vertex at a first point in time is in contact with a digital canvas;
identifying a first bristle imprint based on the modified spatial location of a first bristle vertex at the first point in time; and
rendering a digital stroke based on the first bristle imprint.

19. The method of claim 18, further comprising rendering the digital stroke based on the first bristle imprint by:
identifying a second bristle imprint based on a second modified spatial location of the first bristle vertex at a second point in time; and
providing a single drawing call to a graphical processing unit (GPU) that causes the GPU to render the digital stroke from the single drawing call based on the first bristle imprint at the first point in time and the second bristle imprint at the second point in time.

20. The method of claim 19, further comprising rendering the digital stroke from the single drawing call, for each pixel in the digital stroke, by:
identifying a plurality of contact bristle vertices for the pixel by interpolating between the first bristle imprint and the second bristle imprint;
determining a plurality of color values corresponding to the plurality of contact bristle vertices for the pixel; and
rendering the pixel based on the plurality of color values.
